(19) United States
(12) Patent Application Publication
(10) Pub. No.: US 2024/0271003 A1
(43) Pub. Date: Aug. 15, 2024

(54) WATERBORNE COATING COMPOSITION

(71) Applicant: ALLNEX NETHERLANDS B.V., Bergen Op Zoom (NL)

(72) Inventors: Wouter Marinus Jacobus KLOOSTERMAN, ROTTERDAM (NL); Robert HARRER, Graz (AT)

(73) Assignee: ALLNEX NETHERLANDS B.V., Bergen Op Zoom (NL)

(21) Appl. No.: 18/569,041

(22) PCT Filed: Jun. 14, 2022
(86) PCT No.: PCT/EP2022/066094

§ 371 Date: Dec. 11, 2023

(30) Foreign Application Priority Data
Jun. 15, 2021 (EP) 21179505.9

(51) Int. Cl. C09D 175/14; C08G 18/62; C08G 18/73; C09D 5/02

(52) U.S. Cl. CPC C09D 175/14; C08G 18/6254; C08G 18/73; C09D 5/022

(57) ABSTRACT

The present invention relates to a polyacrylate dispersion comprising a multiphase acrylic polymer, the multiphase acrylic polymer comprising at least one vinyl polymer phase VP1 and one vinyl polymer phase VP2. the multiphase acrylic polymer being prepared by multiple step emulsion polymerization. The present invention also relates to an aqueous coating composition comprising the polyacrylate dispersion, a polyurethane dispersion, and a polyisocyanate crosslinker; to the use thereof in aqueous base coats. especially suitable in, but not limited to, automotive industry.

### TECHNICAL FIELD

The present invention relates to a polyacrylate dispersion comprising a multiphase acrylic polymer and to an aqueous coating composition comprising the polyacrylate dispersion, a polyurethane dispersion, and a polyisocyanate crosslinker. The present invention also relates to the use thereof in aqueous base coats, especially suitable in, but not limited to, automotive industry. The polyacrylate dispersion of the invention is an aqueous polyacrylate dispersion.

### DESCRIPTION OF THE RELATED ART

In, for example, the automotive industry, often coating compositions are used containing metallic pigments, such as aluminum, or a pigment, such as a metal oxide-coated mica, to obtain a coating having a metallic appearance, i.e. having a differential light reflection effect depending on the viewing angle (also called “flop”). A known problem in the art with coating systems having such a metallic appearance is to obtain a high flop and at the same time maintain a high gloss as well.

To obtain a high flop, the metallic pigment on application of the coating composition should be (and should remain) well oriented, and to obtain a high gloss, an unpigmented top coat (the clear coat) is then applied over the metallic pigment-containing coat (the base coat). The resulting coating system is generally referred to as “base coat/clear coat” system. When applying the top coat for obtaining such systems, one should take care not to modify the characteristics of the underlying base coat, such as the desired high flop.

Various base coat/clear coat systems have already been described in the art.

EP 0 038 127 B1 relates to a multi-layer coating process involving use of an aqueous base coat composition containing crosslinked polymer microparticles and having a pseudoplastic or thixotropic character, more particularly, it relates to a process for producing a multi-layer coating upon a substrate surface, in which there is first applied to the surface a pigmented base coat composition and then there is applied to the base coat film a transparent top coat composition; characterized in that the base coat composition is based upon a dispersion in an aqueous medium of crosslinked polymer microparticles which have a diameter of 0.01-10 microns, are insoluble in the aqueous medium and are stable towards gross flocculation, the dispersion having a pseudoplastic or thixotropic character. In the base coat composition of EP 0 038 127 B1, the presence of crosslinked polymer microparticles is essential and shown to confer upon the film derived from said composition the desired ability to withstand subsequent application of the top coat composition without disturbance of the film or of the pigmentation, in particular metallic pigmentation, which it contains and without which a successful base coat/clear coat system cannot be achieved.

EP 0 287 144 B2 relates to an aqueous coating composition having a basis of a dispersion of an addition polymer (acting as binder), particularly as a base coat which is to be covered with a clear coat. To obtain layers having improved mechanical properties use is made of an addition polymer which is obtained in two or more steps by emulsion polymerization. In a first step copolymerization is effected of 60-95 parts b.w., based on 100 parts b.w. of addition polymer, of a monomer mixture comprising (A) 65-100 mole % of a mixture of 60-100 mole % of a (cyclo)alkyl (meth)acrylate, in which the (cyclo)alkyl group contains 4-12 C-atoms, and 0-40 mole % of a di(cyclo)alkyl maleate and/or a di(cyclo)alkyl fumarate, in which the (cyclo)alkyl groups contain 4-12 C-atoms, and 0-35 mole % of another, copolymerizable, monoalkylenically unsaturated monomer, and in a subsequent step of 5-40 parts b.w., based on 100 parts b.w. of addition polymer, of a monomer mixture (B) of 10-60 mole % of (meth)acrylic acid and 40-90 mole % of another copolymerizable, monoalkylenically unsaturated monomer, the (meth)acrylic acid moieties being at least partially ionized. In EP 0 287 144 B2, copolymerization of the monomer mixture B will yield a copolymer having an acid number of 30-450 and preferably of 60-350, and a hydroxyl number of 0-450 and preferably of 60-300.

EP 1 093 496 B1 relates to an aqueous coating composition comprising a mixture of 90 to 99 wt. % of a film forming binder composition comprising an alkali non-swellable core-shell addition polymer dispersion (I), and 1-10 wt. % of a rheology modifying addition polymer dispersion (II). It is required that the total amount of (meth)acrylic acid in 100 parts of the total addition polymer (I) is less than 1.75 wt. %. The polymer dispersion (I) is prepared in two or more steps by emulsion polymerization, and obtained by copolymerization in a first step of (1) 60-95 parts by weight of a monomer mixture A consisting of (i) 65-100 mole % of a mixture comprising inter alia 10-98 mole % of a (cyclo)alkyl (meth)acrylate of which the (cyclo)alkyl group contains 4-12 carbon atoms and 2-15 mole % hydroxy alkyl (meth)acrylate, and (ii) 0-35 mole % of a different copolymerizable monoethylenically unsaturated monomer, and by copolymerization in a subsequent step of (2) 5-40 parts by weight of a monomer mixture B consisting of 1-10 mole % (meth)acrylic acid, 2-20 mole % hydroxy alkyl (meth)acrylate, 0-55 mole % styrene, and 15-97 mole % of a different copolymerizable monoethylenically unsaturated monomer. The aqueous coating composition can be advantageously used as a base coat in a base coat/clear coat system.

EP 2 695 680 B1 relates to a multilayer coating film-forming method that allows formation of a multilayer coating film with excellent smoothness, sharpness and water resistance, and which avoids or minimizes pinhole popping. One of the multilayer coating film-forming methods described, comprises the following steps (1) to (4): step (1): coating an article to be coated with an aqueous first pigmented coating composition (X), step (2): coating the article to be coated, with an aqueous second pigmented coating composition (Y), step (3): coating the article to be coated, with a clear coating composition (Z), and step (4): heating an uncured first pigmented coating film, uncured second pigmented coating film and uncured clear coating film to cure them, wherein the aqueous first pigmented coating composition (X) contains (A) a hydroxyl-containing resin and (B) a blocked polyisocyanate compound. The hydroxyl-containing resin (A) comprises a water-dispersible hydroxyl-containing acrylic resin which is preferably a core-shell type. A preferred core-shell type water-dispersible hydroxyl-containing acrylic resin in EP 2 695 680 B1 comprises a copolymer (I) as the core section whose copolymerizing components are a polymerizable unsaturated monomer having two or more polymerizable unsaturated groups in the molecule and a polymerizable unsaturated monomer having one polymerizable unsaturated group in the molecule, and a copolymer (II) as the shell section. The polymerizable unsaturated monomer with two or more polymerizable unsaturated groups in the molecule has the function of imparting a crosslinked structure to the core section copolymer (I). The core section copolymer (I) contains the polymerizable unsaturated monomer with two or more polymerizable unsaturated groups in the molecule in the range of preferably about 0.1 to about 30 mass %. The core-shell type acrylic resin in EP 2 695 680 B1 can then be obtained by emulsion polymerization of a monomer mixture comprising about 0.1 to about 30 mass % of a polymerizable unsaturated monomer with two or more polymerizable unsaturated groups in the molecule and about 70 to about 99.9 mass % of a polymerizable unsaturated monomer with one polymerizable unsaturated group in the molecule to obtain an emulsion of a core section copolymer (I), and then adding to the emulsion a monomer mixture comprising about 1 to about 40 mass % of a hydroxyl-containing polymerizable unsaturated monomer, about 0.1 to about 30 mass % of a carboxyl group-containing polymerizable unsaturated monomer and about 30 to about 98.9 mass % of another polymerizable unsaturated monomer, and further conducting emulsion polymerization to form a shell section copolymer (II).

A need still exists for an aqueous coating composition to be used as base coat in a base coat/clear coat system, providing a coating system combining good overall coating properties (such as mechanical properties, chemical and water resistance etc.) with good flop and gloss.

### SUMMARY OF INVENTION

According to an aspect of the present invention, there is therefore provided a polyacrylate dispersion, as set out in the appended claims.

According to another aspect of the invention, there is provided an aqueous coating composition comprising said polyacrylate dispersion, as set out in the appended claims.

According to other aspects of the invention, an article coated with the coating composition, and use of the polyacrylate dispersion and the aqueous coating composition are provided as well, as set out in the appended claims.

Advantageous aspects of the present invention are set out in the (dependent) claims and are further discussed in the description below.

### DETAILED DESCRIPTION OF THE INVENTION

This invention relates to a polyacrylate dispersion (or acrylic dispersion) comprising a multiphase acrylic polymer, characterized in that the multiphase acrylic polymer comprises at least two (polymer) phases:
1) a first phase of vinyl polymer VP1 comprising:
   a) 0-75 mole %, preferably 0-65 mole %, more preferably 0-60 mole %, even more preferably 0-57 mole %, most preferably 0-55 mole % of a (cyclo)alkyl (meth)acrylate (preferably (cyclo)alkyl (meth)acrylates) of which the (cyclo)alkyl group contains 4-12 carbon atoms;
   b) 10-60 mole %, preferably 15-50 mole %, more preferably 15-40 mole %, even more preferably 15-35 mole %, still even more preferably 20-30 mole %, most preferably 25-30 mole % of hydroxyalkyl(meth)acrylate(s) (as OH-containing copolymerizable, monoethylenically unsaturated monomer(s)); and
   c) 0-25 mole %, preferably 0 mole %, of a different, copolymerizable, monoethylenically unsaturated monomer (preferably different, copolymerizable, monoethylenically unsaturated monomers),
   d) 0-5 mole %, preferably 0-2 mole %, more preferably 0-1 mole %, of an acid functional monoethylenically unsaturated monomer (preferably acid functional monoethylenically unsaturated monomers),
wherein the sum of mole percentages (mole %) of a), b), c) and d) does not exceed 100% (in the preferred case that a reactive emulsifier is used in VP1, its amount has to be taken into account into the composition of VP1 as well, vide infra),
and
2) a second phase of vinyl polymer VP2 comprising:
   a) 0-50 mole %, preferably 10-40 mole %, more preferably 20-30 mole % of an acid functional monoethylenically unsaturated monomer (preferably acid functional monoethylenically unsaturated monomers); and
   b) 50-100 mole %, preferably 60-90 mole %, more preferably 70-80 mole % of a hydroxyalkyl (meth)acrylate (preferably hydroxyalkyl (meth)acrylates) or a different, copolymerizable, monoethylenically unsaturated monomer (preferably different, copolymerizable, monoethylenically unsaturated monomers), or a mixture thereof,
wherein the sum of mole percentages (mole %) of a) and b) does not exceed 100%.

The polyacrylate dispersion of the invention is an aqueous polyacrylate dispersion.

The acid value (AV, or acid number) of vinyl polymer VP1 is lower or equal to 30 mg KOH per gram of vinyl polymer VP1 (i.e. the acid value of VP1 ranges from 0 up to (and including) 30 mg KOH/g vinyl polymer VP1, 0≤ acid value of vinyl polymer VP1 ≤30).

In the present application, “acid value” of vinyl polymer VP1, vinyl polymer VP2, and multiphase acrylic polymer refers to the theoretical acid value and can be calculated by the following equation, Eq. (I), where the dimensions used are given between round brackets:

$$Theoretical AV ( mg KOH / g ) = [ number of moles of acid monomers ( mole ) * 56.1 ( g / mole ) * 1000 ( mg / g ) ] / weight ( g ) of the polymer ,$$

where weight of the polymer refers to the mass (in g) of solid polymer of VP1, VP2, or multiphase acrylic polymer under consideration, respectively. It is apparent for those skilled in the art that for acid monomers (or acid containing monomers, or acidic monomers) having more than one acid group, i.e. for difunctional acid monomers, trifunctional acid monomers, etc., Eq. (I) is to be multiplied by 2, 3, etc., respectively.

Throughout the present description, the term “acid value” of vinyl polymer VP1, vinyl polymer VP2, and multiphase acrylic polymer is thus referring to the calculated (or theoretical) acid value, as calculated using the above, well-known equation Eq. (I).

In the context of the present description, a “polyacrylate dispersion” (or acrylic dispersion) refers to a dispersion comprising (co)polymers of acrylic monomers, vinyl monomers, and/or also aromatic ring-containing polymerizable unsaturated monomers such as for example styrene. Throughout the present description, the term “polyacrylate dispersion” (or “acrylic dispersion”) refers to an aqueous polyacrylate dispersion (or an aqueous acrylic dispersion).

In the context of the present description, “the multiphase acrylic polymer comprises at least two phases” refers to a multiphase acrylic polymer comprising two, three or more phases, preferably two, three or more polymer phases. In case three or more (polymer) phases are present in the multiphase acrylic polymer, the mole percentages indicated for vinyl polymer VP1 hereabove are to be considered over the total of vinyl polymer VP1 phases present in the multiphase acrylic polymer. For example, in case the multiphase acrylic polymer comprises three (polymer) phases of which two vinyl polymer VP1 phases and one vinyl polymer VP2 phase, the mole percentages indicated for vinyl polymer VP1 hereabove are to be considered over the total of the two vinyl polymer VP1 phases present in the multiphase acrylic polymer.

In the context of the present description, vinyl polymer VP1 is also referred to as vinyl polymer VP1 phase, VP1 phase, first phase, phase 1, or VP1, of the multiphase acrylic polymer.

In the context of the present description, vinyl polymer VP2 is also referred to as vinyl polymer VP2 phase, VP2 phase, second phase, phase 2, or VP2, of the multiphase acrylic polymer.

In the context of the present description, the prefix “(meth)acryl”, when used to name compounds, encompasses both “acryl” and “methacryl”, and refers to compounds comprising at least one CH₂═CHCOO— group or CH₂═CCH₃COO— group, respectively, as well as to compounds comprising at least one CH₂═CHCOO— group and CH₂═CCH₃COO— group, and to mixtures of such compounds.

### Vinyl Polymer VP1

Preferably, in VP1, the (cyclo)alkyl (meth)acrylate(s) of which the (cyclo)alkyl group contains 4-12 carbon atoms is (are) selected from the group consisting of n-butyl (meth)acrylate, isobutyl (meth)acrylate, tert-butyl (meth)acrylate, n-hexyl (meth)acrylate, 2-ethylhexyl (meth)acrylate, octyl (meth)acrylate, nonyl (meth)acrylate, isobornyl (meth)acrylate, dodecyl (meth)acrylate, cyclohexyl (meth)acrylate, methylcyclohexyl (meth)acrylate, tert-butylcyclohexyl (meth)acrylate, cyclododecyl (meth)acrylate, and mixtures thereof. More preferably, the (cyclo)alkyl (meth)acrylate(s) of which the (cyclo)alkyl group contains 4-12 carbon atoms, if present in VP1, is (are) n-butyl acrylate (n-BA), butyl methacrylate (BMA), 2-ethylhexyl (meth)acrylate (2-EH(M)A), or a mixture thereof.

Preferably, the hydroxyalkyl (meth)acrylate(s) in VP1 is (are) selected from the group consisting of 2-hydroxyethyl (meth)acrylate, 2-hydroxypropyl (meth)acrylate, 4-hydroxybutyl (meth)acrylate, 6-hydroxyhexyl (meth)acrylate, p-hydroxycyclohexyl (meth)acrylate, 2,3-dihydroxypropyl (meth)acrylate, and a mixture thereof. More preferably, the hydroxyalkyl (meth)acrylate(s) in VP1 is (are) selected from the group consisting of 2-hydroxyethyl (meth)acrylate, 2-hydroxypropyl (meth)acrylate, 4-hydroxybutyl (meth)acrylate, 6-hydroxyhexyl (meth)acrylate, p-hydroxycyclohexyl (meth)acrylate, and a mixture thereof. Even more preferably, the hydroxyalkyl (meth)acrylate(s) is (are) 2-hydroxyethyl methacrylate (2-HEMA), 2-hydroxyethyl acrylate (2-HEA), 4-hydroxybutyl acrylate (4-HBA), or a mixture thereof.

In the context of the present description, “different, copolymerizable, monoethylenically unsaturated monomer(s) present in the VP1 phase of the multiphase acrylic polymer” refers to a copolymerizable, monoethylenically unsaturated monomer being different (i.e. not being identical) to the (cyclo)alkyl (meth)acrylate(s) of which the (cyclo)alkyl group contains 4-12 carbon atoms present in the VP1 phase and being different to the hydroxyalkyl (meth)acrylate(s) present in the VP1 phase and being different to the acid functional monoethylenically unsaturated monomer(s) present in the VP1 phase of the multiphase acrylic polymer. In other words, the different, copolymerizable, monoethylenically unsaturated monomers present in VP1 are copolymerizable, monoethylenically unsaturated monomers being different to the (cyclo)alkyl (meth)acrylate(s) of which the (cyclo)alkyl group contains 4-12 carbon atoms, the hydroxyalkyl (meth)acrylate(s) and the acid functional monoethylenically unsaturated monomer(s) in VP1.

The different, copolymerizable, monoethylenically unsaturated monomer(s) in VP1 can be alkyl (meth)acrylates of which the alkyl group contains 1-3 carbon atoms, for example methyl (meth)acrylate (MMA), ethyl (meth)acrylate, n-propyl (meth)acrylate, isopropyl (meth)acrylate; alkyl or cycloalkyl (meth)acrylates of which the (cyclo)alkyl group contains more than 12 carbon atoms (i.e. of which the (cyclo)alkyl group contains 13 carbon atoms or more), for example tridecyl (meth)acrylate, octadecyl (meth)acrylate, iso-octadecyl (meth)acrylate; aromatic ring-containing polymerizable unsaturated monomers, for example benzyl (meth)acrylate, styrene, a-methyl styrene, o-, m- and p-methylstyrene, o-, m- and p-ethyl styrene, vinyl toluene; nitrogen-containing polymerizable unsaturated monomers, for example (meth)acrylamide, N-vinylpyrrolidone, N,N-dimethylaminoethyl (meth)acrylate, N,N-diethylaminoethyl (meth)acrylate, N,N-dimethylaminopropyl (meth)acrylamide; polymerizable unsaturated monomers with carbonyl or epoxy groups, for example diacetone (meth)acrylamide, acetoacetoxyethyl methacrylate, glycidyl (meth)acrylate, 2-methylglycidyl (meth)acrylate; polymerizable unsaturated monomers with alkoxysilyl groups, for example vinyl trimethoxysilane, vinyl triethoxysilane, vinyl tris(2-methoxyethoxy)silane, γ-(meth)acryloyloxypropyltrimethoxysilane, γ-(meth)acryloyloxypropyltriethoxysilane, or a mixture thereof. If present, the different, copolymerizable, monoethylenically unsaturated monomer(s) in VP1 is (are) preferably methyl (meth)acrylate, (meth)acrylamide, styrene, or a mixture thereof, most preferably methyl methacrylate, styrene, or a mixture thereof.

In VP1 an acid functional monoethylenically unsaturated monomer (or acid functional monoethylenically unsaturated monomers) can also be present, being an unsaturated monomer with acid functionality, which include monomers of which the acid groups are latent. More preferably, the acid functional monoethylenically unsaturated monomer(s) is (are) suitably selected from, but not limited to, the group of: (meth)acrylic acid; oligomerized acrylic acids such as 2-carboxyethyl acrylate (CEA) or its higher analogues (commercially available from Solvay as SIPOMER® β-CEA); itaconic acid, fumaric acid, maleic acid, citraconic acid or the anhydrides thereof; monoalkyl maleates (for example monomethyl maleate and monoethyl maleate), monoalkylcitraconates, acid phosphooxyethyl (meth)acrylate, acid phosphooxypropyl (meth)acrylate, acid phosphooxypoly(oxyethylene)glycol (meth)acrylate, acid phosphooxypoly(oxypropylene)glycol (meth)acrylates, styrene p-sulphonic acid, ethylmethacrylate-2-sulfonic acid, allylsulfonic acid, 3-sulfopropyl methacrylate, 2-acrylamido-2-methylpropane sulfonic acid, and mixtures thereof. An acid bearing monomer can be polymerized as the free acid or as a salt (e.g. the ammonium or alkali metal salts), or as a mixture thereof. In case the acid functional monoethylenically unsaturated monomer comprises carboxylic groups, the carboxylic groups derived from the acid are at least partially ionized. If present, the acid functional monoethylenically unsaturated monomer(s) in VP1 is (are) preferably a carboxylic acid, more preferably (meth)acrylic acid.

Preferably, vinyl polymer VP1 comprises 0-1 mole % of an acid functional monoethylenically unsaturated monomer (or preferably acid functional monoethylenically unsaturated monomers).

Optionally, a crosslinker is present in vinyl polymer VP1. The crosslinker can be a monofunctional or difunctional ethylenically unsaturated monomer, such as allyl (meth)acrylate, 1,6-hexanediol di(meth)acrylate, methylenebis(meth)acrylamide, ethylenebis(meth)acrylamide, or divinyl benzene, or a mixture thereof. Crosslinking in vinyl polymer VP1 can also be achieved by combining two or more copolymerizable, monoethylenically unsaturated monomers with pendant functional groups that can react with co-reactive functional groups. Examples of suitable co-reactive functional groups for given pendant functional groups are known to those skilled in the art. Non-limiting examples are given in following Table 1.

TABLE 1

| Pendant functional | |
|---|---|
| group | Co-reactive functional groups |
| Amine | Oxirane, isocyanate, ketone, aldehyde, acetoacetoxy |
| Hydroxy | Methylol, etherified methylol, isocyanate, aldehyde |
| Ketone | Amino, hydrazide |
| Acetoacetoxy, | Amino, isocyanate, aldehyde, metal-ion, hydrazide |
| acetoacetamide | |
| Aldehyde | Amino, hydrazide |
| Urea | Glyoxal |
| Oxirane | Carboxylic acid, amino, thiol |
| Carboxyl | Aziridine, oxirane, carbodiimide, metal-ion |

If present in vinyl polymer VP1, the amount of crosslinker preferably ranges between 0.01 and 3% by weight, more preferably between 0.1 and 1.0% by weight based on the weight of vinyl polymer VP1.

Preferably, vinyl polymer VP1 is not containing any groups which react with each other (so that a non-cross-linked vinyl polymer VP1 is formed). More preferably, the (intentional) use of crosslinkers is completely omitted (for forming vinyl polymer VP1), i.e. no crosslinker is present in vinyl polymer VP1 or vinyl polymer VP1 comprises 0.0% crosslinker.

### Vinyl Polymer VP2

Preferably, the acid functional monoethylenically unsaturated monomer(s) in VP2 is (are) an unsaturated monomer with acid functionality, which include monomers of which the acid groups are latent. More preferably, the acid functional monoethylenically unsaturated monomer(s) is (are) suitably selected from, but not limited to, the group of: (meth)acrylic acid; oligomerized acrylic acids such as 2-carboxyethyl acrylate (CEA) or its higher analogues (commercially available from Solvay as SIPOMER® β-CEA); itaconic acid, fumaric acid, maleic acid, citraconic acid or the anhydrides thereof; monoalkyl maleates (for example monomethyl maleate and monoethyl maleate), monoalkylcitraconates, acid phosphooxyethyl (meth)acrylate, acid phosphooxypropyl (meth)acrylate, acid phosphooxypoly(oxyethylene)glycol (meth)acrylate, acid phosphooxypoly(oxypropylene)glycol (meth) acrylates, styrene p-sulphonic acid, ethylmethacrylate-2-sulfonic acid, allylsulfonic acid, 3-sulfopropyl methacrylate, and 2-acrylamido-2-methylpropane sulfonic acid, and mixtures thereof. An acid bearing monomer can be polymerized as the free acid or as a salt (e.g. the ammonium or alkali metal salts), or as a mixture thereof. In case the acid functional monoethylenically unsaturated monomer comprises carboxylic groups, the carboxylic groups derived from the acid are at least partially ionized. The acid functional monoethylenically unsaturated monomer(s) in VP2 is (are) preferably a carboxylic acid. More preferably, the acid functional monoethylenically unsaturated monomer(s) in VP2 is (are) (meth)acrylic acid.

In the context of the present description, “carboxylic acid groups derived from the acid are at least partially ionized” refers to at least part of the carboxylic acid groups, derived from the acid, being ionized.

Preferably, the hydroxyalkyl (meth)acrylate(s) in VP2 is (are) selected from the group consisting of 2-hydroxyethyl (meth)acrylate, 2-hydroxypropyl (meth)acrylate, 4-hydroxybutyl (meth)acrylate, 6-hydroxyhexyl (meth)acrylate, p-hydroxycyclohexyl (meth)acrylate, 2,3-dihydroxypropyl methacrylate, and a mixture thereof. More preferably, the hydroxyalkyl (meth)acrylate(s) in VP2 is (are) selected from the group consisting of 2-hydroxyethyl (meth)acrylate, 2-hydroxypropyl (meth)acrylate, 4-hydroxybutyl (meth)acrylate, 6-hydroxyhexyl (meth)acrylate, p-hydroxycyclohexyl (meth)acrylate, and a mixture thereof. Even more preferably, the hydroxyalkyl (meth)acrylate(s) is (are) 2-hydroxyethyl methacrylate (2-HEMA), 2-hydroxyethyl acrylate (2-HEA), 4-hydroxybutyl acrylate (4-HBA), or a mixture thereof.

In the context of the present description, “different, copolymerizable, monoethylenically unsaturated monomer(s) present in the VP2 phase of the multiphase acrylic polymer” refers to a copolymerizable, monoethylenically unsaturated monomer being different (i.e. not being identical) to the acid functional monoethylenically unsaturated monomer(s) present in the VP2 phase and being different to the hydroxyalkyl (meth)acrylate(s) present in the VP2 phase. In other words, the different, copolymerizable, monoethylenically unsaturated monomers present in VP2 are copolymerizable, monoethylenically unsaturated monomers being different to the acid functional monoethylenically unsaturated monomer(s) and the hydroxyalkyl (meth)acrylate(s) in VP2.

The different, copolymerizable, monoethylenically unsaturated monomer(s) (in VP2) can be alkyl (meth)acrylates of which the alkyl group contains 1-3 carbon atoms, for example methyl (meth)acrylate (MMA), ethyl (meth)acrylate, n-propyl (meth)acrylate, isopropyl (meth)acrylate; alkyl or cycloalkyl (meth)acrylates of which the (cyclo)alkyl group contains more than 12 carbon atoms, for example tridecyl (meth)acrylate, octadecyl (meth)acrylate, iso-octadecyl (meth)acrylate; aromatic ring-containing polymerizable unsaturated monomers, for example benzyl (meth)acrylate, styrene, a-methyl styrene, o-, m- and p-methylstyrene, o-, m- and p-ethylstyrene, vinyl toluene; nitrogen-containing polymerizable unsaturated monomers, for example (meth)acrylamide, N-vinylpyrrolidone, N,N-dimethylaminoethyl (meth)acrylate, N,N-diethylaminoethyl (meth)acrylate, N,N-dimethylaminopropyl (meth)acrylamide; polymerizable unsaturated monomers with carbonyl or epoxy groups, for example diacetone (meth)acrylamide, acetoacetoxyethyl methacrylate, glycidyl (meth)acrylate, 2-methylglycidyl (meth)acrylate; polymerizable unsaturated monomers with alkoxysilyl groups, for example vinyl trimethoxysilane, vinyl triethoxysilane, vinyl tris(2-methoxyethoxy)silane, γ-(meth)acryloyloxypropyltrimethoxysilane, γ-(meth)acryloyloxypropyltriethoxysilane, or a mixture thereof.

The different, copolymerizable, monoethylenically unsaturated monomer(s) (in VP2) can also be (cyclo)alkyl (meth)acrylate of which the (cyclo)alkyl group contains 4-12 carbon atoms selected from the group consisting of n-butyl (meth)acrylate, isobutyl (meth)acrylate, tert-butyl (meth)acrylate, n-hexyl (meth)acrylate, 2-ethylhexyl (meth)acrylate, octyl (meth)acrylate, nonyl (meth)acrylate, isobornyl (meth)acrylate, dodecyl (meth)acrylate, cyclohexyl (meth)acrylate, methylcyclohexyl (meth)acrylate, tert-butylcyclohexyl (meth)acrylate, cyclododecyl (meth)acrylate, and mixtures thereof.

More preferably, the different, copolymerizable, monoethylenically unsaturated monomer(s) present in VP2 is (are) n-butyl (meth)acrylate, methyl (meth)acrylate, styrene, or a mixture thereof, most preferably n-butyl acrylate, methyl methacrylate, or a mixture thereof.

Preferably, vinyl polymer VP2 is not containing any groups which react with each other (so that a non-cross-linked vinyl polymer VP2 is formed). More preferably, the (intentional) use of crosslinkers is completely omitted for forming vinyl polymer VP2, i.e. no crosslinker is present in vinyl polymer VP2, or vinyl polymer VP2 comprises 0.0% crosslinker.

The acid functional monoethylenically unsaturated monomers for vinyl polymer VP1 and VP2 may be produced from petrochemical feedstock. Alternatively, they may be derived from renewable feedstock (i.e. the monomers are obtained in part or fully from (bio-)renewable sources) such as bio-based acrylic acid, methacrylic acid, itaconic acid and methyl methacrylate. The alkanols used in the (trans)esterification can also be bio-derived. Non-limiting examples of such bio-based monomers are VISIOMER® Terra C13-MA, VISIOMER® Terra C17.4-MA, 2-octyl acrylate, isobornyl methacrylate and isobornyl acrylate.

The content of renewable carbon present in the monomers described above can be calculated from the monomers structural formula or can be measured according to ASTM D6866A (or ASTM D6866-20). The bio-based carbon content is reported as the fraction of total organic carbon content (TOC). Other standardized methods to determine the fraction of renewable carbon are ISO 16620-2 and CEN 16640.

Another alternative method for reducing the carbon footprint of the polymer dispersions of the invention is to use recycled monomers for the preparation thereof. Polymers, such as poly(methyl methacrylate) or poly(styrene), can be pyrolyzed at temperatures above their ceiling temperature. By distillation of the pyrolysis products, recycled monomers, such as methyl methacrylate or styrene, can be obtained which can then be further used in the emulsion polymerization for preparing the aqueous polyacrylate dispersion of the present invention.

In yet another alternative, the monoethylenically unsaturated monomers for vinyl polymer VP1 and/or VP2 are obtained from petrochemical feedstock and/or renewable feedstock, and/or are recycled monomers (where possible).

Preferably, the monoethylenically unsaturated monomers for vinyl polymer VP1 and/or VP2 are obtained from renewable feedstock, and/or are recycled monomers (where possible, such as recycled methyl methacrylate or recycled styrene).

More preferably, the monoethylenically unsaturated monomers for vinyl polymer VP1 and/or VP2 are obtained from renewable feedstock and have a bio-based carbon content of more than 20% by weight of total carbon content of the monomer, the bio-carbon content being determined using the ASTM D6866-20 standard.

The multiphase acrylic polymer of the present invention is being prepared by multiple step emulsion polymerization (comprising at least the following two subsequent steps i) and ii):
i. preparing (polymerizing) 70-95, preferably 75-90, parts by weight (calculated on 100 parts by weight of the prepared copolymer) of vinyl polymer VP1, and subsequently
ii. preparing (polymerizing) 5-30, preferably 10-25, parts by weight (calculated on 100 parts by weight of the prepared copolymer) of vinyl polymer VP2, in the presence of vinyl polymer VP1;
or
i. preparing (polymerizing) 5-30, preferably 10-25, parts by weight (calculated on 100 parts by weight of the prepared copolymer) of vinyl polymer VP2, and subsequently
ii. preparing (polymerizing) 70-95, preferably 75-90, parts by weight (calculated on 100 parts by weight of the prepared copolymer) of vinyl polymer VP1, in the presence of vinyl polymer VP2.

Preferably, the multiphase acrylic polymer of the present invention is being prepared by multiple step emulsion polymerization comprising at least the following two subsequent steps i) and ii):
i. preparing (polymerizing) 70-95, preferably 75-90, parts by weight (calculated on 100 parts by weight of the prepared copolymer) of vinyl polymer VP1, and subsequently
ii. preparing (polymerizing) 5-30, preferably 10-25, parts by weight (calculated on 100 parts by weight of the prepared copolymer) of vinyl polymer VP2, in the presence of vinyl polymer VP1.

In the context of the present application, “multiple step” polymerization refers to a polymerization performed in at least two steps, more particularly to a sequential polymerization performed in two or more steps. It is well known by the skilled person in the art that in such multiple step polymerization, the subsequent step will only be initiated when the conversion from monomers to polymer in the previous step is sufficiently high. It will be apparent for those skilled in the art when the conversion in the previous step is sufficiently high. For example, a subsequent (or second step) of polymerizing will only be initiated when less than about 500 ppm monomers are still present in the reaction mixture that was used for performing the previous (or first step) of polymerizing.

In the context of the present application, “emulsion polymerization” refers to addition polymerization where an ethylenically unsaturated monomer is polymerized in water in the presence of a water-soluble or water insoluble initiator. A general description of the process of emulsion polymerization is given by E.W. Duck in Encyclopedia of Polymer Science and Technology, 1966, John Wiley & Sons, Inc., Vol 5, p 801-859.

In the present invention, the emulsion polymerization can be a free-radical emulsion polymerization of vinyl monomers requiring the use of free-radical-yielding initiators to initiate the vinyl polymerization. Suitable free-radical-yielding initiators include inorganic peroxides (such as sodium, potassium or ammonium persulphate), hydrogen peroxide, or percarbonates; organic peroxides (such as acyl peroxides, including e.g. benzoyl peroxide), alkyl hydroperoxides (such as t-butyl hydroperoxide and cumene hydroperoxide); dialkyl peroxides (such as di-t-butyl peroxide); peroxy esters (such as t-butyl perbenzoate), and the like; mixtures thereof may also be used. Preferably, the emulsion polymerization is a seeded emulsion polymerisation.

The peroxy compounds are in some cases advantageously used in combination with suitable reducing agents (redox systems) such as sodium pyrosulphite or bisulphite, potassium pyrosulphite or bisulphite, sodium formaldehyde sulphoxylate, disodium 2-hydroxy-2-sulfinicacetic acid and iso-ascorbic acid. Metal compounds such as Fe.EDTA (EDTA being the abbreviation for ethylene diamine tetra acetate) may also be used as part of the redox initiator system. Azo functional initiators may also be used. Preferred azo-initiators include azobis(isobutyronitrile), 2,2′-azo-bis(2-methyl butane nitrile) (ANBN), and 4,4′-azobis(4-cyanovaleric acid). It is possible to use an initiator partitioning between the aqueous and organic phases, e.g. a combination of t-butyl hydroperoxide, iso-ascorbic acid and Fe.EDTA. The amount of initiator or initiator system to use is conventional, e.g. within the range 0.05 to 6 wt % based on the total vinyl monomer(s) used.

The polyacrylate dispersion of the present invention thus comprises a multiphase acrylic polymer, the multiphase acrylic polymer comprising at least a vinyl polymer VP1 and a vinyl polymer VP2, said multiphase acrylic polymer being prepared in 2 or more steps by emulsion polymerization, and preferably obtained
by copolymerization, in a first step of 70-95, preferably 75-90, parts by weight (calculated on 100 parts by weight of the addition polymer) of a monomer mixture A comprising:
   a) 0-75 mole %, preferably 0-65 mole %, more preferably 0-60 mole %, even more preferably 0-57 mole %, most preferably 0-55 mole % of a (cyclo)alkyl (meth)acrylate (preferably (cyclo)alkyl (meth)acrylates) of which the (cyclo)alkyl group contains 4-12 carbon atoms;
   b) 10-60 mole %, preferably 15-50 mole %, more preferably 15-40 mole %, even more preferably 15-35 mole %, still even more preferably 20-30 mole %, most preferably 25-30 mole % of hydroxyalkyl(meth)acrylate(s) (as OH-containing copolymerizable, monoethylenically unsaturated monomer(s)); and
   c) 0-25 mole %, preferably 0 mole %, of a different, copolymerizable, monoethylenically unsaturated monomer (preferably different, copolymerizable, monoethylenically unsaturated monomers),
   d) 0-5 mole %, preferably 0-2 mole %, more preferably 0-1 mole %, of an acid functional monoethylenically unsaturated monomer (preferably acid functional monoethylenically unsaturated monomers),
   wherein the sum of mole percentages of a), b), c) and d) does not exceed 100%,
thereby preparing vinyl polymer VP1 (first phase of the multiphase acrylic polymer), and
by copolymerization, in a subsequent step in the presence of vinyl polymer VP1, of 5-30, preferably 10-25, parts by weight (calculated on 100 parts by weight of the prepared copolymer) of a monomer mixture B comprising:
   a) 0-50 mole %, preferably 10-40 mole %, more preferably 20-30 mole % of an acid functional monoethylenically unsaturated monomer (preferably acid functional monoethylenically unsaturated monomers); and
   b) 50-100 mole %, preferably 60-90 mole %, more preferably 70-80 mole % of (a) hydroxyalkyl(meth)acrylate(s) or a different, copolymerizable, monoethylenically unsaturated monomer (preferably different, copolymerizable, monoethylenically unsaturated monomers), or a mixture thereof,
   wherein the sum of mole percentages of a) and b) does not exceed 100%,
thereby preparing vinyl polymer VP2 (second phase of the multiphase acrylic polymer).

The multiphase acrylic polymer in the polyacrylate dispersion of the present invention preferably has an OH value (or hydroxyl number) of at least 55 mg KOH/g, preferably of 75-250 mg KOH/g, more preferably of 100-200 mg KOH/g, and most preferably of 100-150 mg KOH/g. The polyacrylate dispersion of the present invention is thus a high OH-functional (waterborne) polyacrylate dispersion, more particularly by having a high content of OH functional monomers in the vinyl polymer phase VP1.

Preferably, the OH functional monomers are present in the vinyl polymer phase VP1 in an amount of at least 20 mole %, more preferably in an amount of at least 25 mole %.

The OH value (or hydroxyl number) of vinyl polymer VP1 is of 100-250 mg KOH/g, preferably of 100-200 mg KOH/g, and more preferably of 100-175 mg KOH/g.

Preferably, the OH value (or hydroxyl number) of vinyl polymer VP2 is of 0-250 mg KOH/g, more preferably of 0-200 mg KOH/g, even more preferably of 0-150 mg KOH/g.

In the present application, the “OH value” of vinyl polymer VP1, vinyl polymer VP2, and multiphase acrylic polymer refers to the theoretical OH value and can be calculated by the following equation, Eq. (II), where the dimensions used are given between round brackets:

$$Theoretical OHV ( mg KOH / g ) = [ \text{} number of moles of hydroxyalkyl ( meth ) acrylate ( s ) ( mole ) * 56.1 ( g / mole ) * 1000 ( mg / g ) ] / weight ( g ) of the polymer ,$$

where weight of the polymer refers to the mass (in g) of solid polymer of VP1, VP2, or multiphase acrylic polymer under consideration, respectively.

More particularly, the “OH value” of vinyl polymer VP1, vinyl polymer VP2, and multiphase acrylic polymer refers to the theoretical OH value calculated by the following equation, Eq. (II′), where the dimensions used are given between round brackets

$$Theoretical OHV ( \text{} mg KOH / g ) = [ \text{} number of moles of hydroxy ‐ functional monomer ( \text{} s ) ( mole ) * 56.1 ( g / mole ) * 1000 ( mg / g ) ] \text{} / weight ( g ) of the polymer ,$$

where weight of the polymer refers to the mass (in g) of solid polymer of VP1, VP2, or multiphase acrylic polymer under consideration, respectively. It is apparent for those skilled in the art, that for hydroxy-functional monomers having more than one hydroxyl group, i.e. for difunctional hydroxyl monomers, trifunctional hydroxyl monomers, etc., Eq. (II′) is to be multiplied by 2, 3, etc., respectively.

Throughout the present description, the term “OH value” of vinyl polymer VP1, vinyl polymer VP2, and multiphase acrylic polymer is thus referring to the calculated (or theoretical) OH value, as calculated using the above, well-known equation Eq. (II) (or Eq. (II′)).

Preferably, the vinyl polymer VP1 of the polyacrylate dispersion of the present invention comprises at least one emulsifier of anionic and/or non-ionic nature, more preferably the emulsifier comprises an olefinically unsaturated group (that can participate in a free radical polymerization), i.e. the emulsifier is a co-polymerizable emulsifier (the latter also referred to as reactive emulsifier). In that case, the amount of reactive emulsifier used has to be taken into account into the composition of VP1 as well, i.e. the sum of mole percentages of (cyclo)alkyl (meth)acrylates (a), hydroxyalkyl (meth)acrylates (b), different, copolymerizable, monoethylenically unsaturated monomers (c), acid functional monoethylenically unsaturated monomers (d) and reactive emulsifier in VP1 should not exceed 100%.

In the context of the present description, the terms (reactive) emulsifier, surfactant solid, emulsifier solid, and reactive surfactant are interchangeably used.

More preferably, the amount of emulsifier solids (active substance or active matter) used in the synthesis of vinyl polymer VP1 is 0.1 to 15 weight %, even more preferably 0.1 to 8 weight %, still even more preferably 0.1 to 5 weight %, most preferably 0.1 to 3 weight % (based on the weight of vinyl polymer VP1).

Suitable polymerizable surfactants include hemi-esters of maleic anhydride of the formula M⁺·- OOC—CH═CHCOOR wherein R is C6 to C22 alkyl and M⁺ is Na⁺, K⁺, Li⁺, NH₄⁺, or a protonated or quaternary amine. Polyoxyethylene alkylphenyl ethers with an ethylenically unsaturated bond sold under the tradename NOIGEN® RN (from Dai-Ichi Kogyo Seiyaku Co., Ltd. of Japan) such as NOIGEN™ RN-10, NOIGEN™ RN-20, NOIGEN™ RN-30, NOIGEN™ RN-40, and NOIGEN™ RN-5065 or the sulphate thereof sold under the tradename HITENOL® BC (from Dai-Ichi Kogyo Seiyaku Co., Ltd. of Japan) such as HITENOL® BC-10, HITENOL® BC-1025, HITENOL® BC-20, HITENOL® BC-2020, HITENOL® BC-30, MAXEMUL® 6106 (available from Croda Industrial Specialties), which has both phosphonate ester and ethoxy hydrophilicity, a nominal C18 alkyl chain with an acrylate reactive group. Other representative reactive surfactants with phosphate ester functionalities suitable for such reactions include, but are not limited to, MAXEMUL® 6112, MAXEMUL® 5011, MAXEMUL® 5010 (all available from Croda Industrial Specialties).

Alternative reactive surfactants suitable for use with various embodiments of the present invention include sodium allyloxy hydroxypropyl sulphonate (available from Solvay as Sipomer® COPS-1), ADEKA REASOAP® SR/ER series such as ADEKA REASOAP® ER-10, ER-20, ER-30 and ER-40, ADEKA REASOAP® SR-10, SR-20, SR-30 (all available from Adeka Corporation., Ltd.) and allylsulphosuccinate derivatives (such as TREM® LF-40, available from BASF).

Preferably, the acid value of vinyl polymer VP2 is higher than 30 mg KOH per gram of vinyl polymer VP2, i.e. the acid value of vinyl polymer VP2 is strictly higher than, and not equal to, 30 mg KOH/g (acid value of vinyl polymer VP2>30 mg KOH/g).

The polyacrylate dispersion of the invention preferably has a solids content of up to 50 wt % (based on the weight of the dispersion), more preferably the solids content is within the range of from 20 to 40 wt %.

Preferably, the aqueous polyacrylate dispersion of the invention comprises a multiphase acrylic polymer, said multiphase acrylic polymer comprising at least two (polymer) phases:
1) a vinyl polymer VP1 comprising:
   a) 0-75 mole %, preferably 0-65 mole %, more preferably 0-60 mole %, even more preferably 0-55 mole % of (cyclo)alkyl (meth)acrylates of which the (cyclo)alkyl group contains 4-12 carbon atoms;
   b) 15-50 mole %, preferably 15-40 mole %, more preferably 15-35 mole %, even more preferably 20-30 mole %, most preferably 25-30 mole % of hydroxyalkyl (meth)acrylates; and
   c) 0-25 mole %, preferably 0 mole % of different, copolymerizable, monoethylenically unsaturated monomers; and
   d) 0-5 mole %, preferably 0-2 mole %, more preferably 0-1 mole %, of acid functional monoethylenically unsaturated monomers,
wherein the sum of mole percentages does not exceed 100% and wherein the acid value of VP1 is lower or equal to 30 mg KOH/g, and wherein the hydroxyl number of vinyl polymer VP1 is of 100-250 mg KOH/g,
and
2) a vinyl polymer VP2 comprising:
   a) 10-40 mole %, preferably 20-30 mole % of acid functional monoethylenically unsaturated monomers), and
   b) 60-90 mole %, preferably 70-80 mole % of hydroxyalkyl (meth)acrylates or different, copolymerizable, monoethylenically unsaturated monomers, or a mixture thereof,
wherein the sum of mole percentages does not exceed 100%,
the multiphase acrylic polymer being prepared by multiple step emulsion polymerization comprising at least the following subsequent steps i) and ii):
i. preparing 70-95, preferably 75-90, parts by weight (calculated on 100 parts by weight of the prepared copolymer) of vinyl polymer VP1, and subsequently
ii. preparing 5-30, preferably 10-25, parts by weight (calculated on 100 parts by weight of the prepared copolymer) of vinyl polymer VP2, in the presence of vinyl polymer VP1.

More particularly, vinyl polymer VP1 comprises 0-75 mole % of (cyclo)alkyl (meth)acrylates of which the (cyclo)alkyl group contains 4-12 carbon atoms; 15-50 mole % of hydroxyalkyl (meth)acrylates; 0-25 mole % of different, copolymerizable, monoethylenically unsaturated monomers; and 0-5 mole % of acid functional monoethylenically unsaturated monomers, wherein the sum of mole percentages does not exceed 100% and wherein the acid value of VP1 is lower or equal to 30 mg KOH/g, and wherein the hydroxyl number of vinyl polymer VP1 is of 100-250 mg KOH/g, and vinyl polymer VP2 comprises 10-40 mole % of acid functional monoethylenically unsaturated monomers), and 60-90 mole % of hydroxyalkyl (meth)acrylates or of different, copolymerizable, monoethylenically unsaturated monomers, or of a mixture thereof, wherein the sum of mole percentages does not exceed 100%. Even more particularly, vinyl polymer VP1 comprises 0-75 mole % of (cyclo)alkyl (meth)acrylates of which the (cyclo)alkyl group contains 4-12 carbon atoms; 15-50 mole % of hydroxyalkyl (meth)acrylates; 0-25 mole % of different, copolymerizable, monoethylenically unsaturated monomers; and 0-5 mole % of acid functional monoethylenically unsaturated monomers, wherein the sum of mole percentages does not exceed 100% and wherein the acid value of VP1 is lower or equal to 30 mg KOH/g, and wherein the hydroxyl number of vinyl polymer VP1 is of 100-250 mg KOH/g, and vinyl polymer VP2 comprises 20-30 mole % of acid functional monoethylenically unsaturated monomers), and 70-80 mole % of hydroxyalkyl (meth)acrylates or of different, copolymerizable, monoethylenically unsaturated monomers, or of a mixture thereof, wherein the sum of mole percentages does not exceed 100%.

In a more preferred embodiment, the polyacrylate dispersion comprises a multiphase acrylic polymer, said multiphase acrylic polymer comprising at least two (polymer) phases:
1) a vinyl polymer VP1 comprising 0-65 mole % of a (cyclo)alkyl (meth)acrylate (preferably (cyclo)alkyl (meth)acrylates) of which the (cyclo)alkyl group contains 4-12 carbon atoms; 15-40 mole % of hydroxyalkyl (meth)acrylate(s); 0 mole % of a different, copolymerizable, monoethylenically unsaturated monomer (preferably different, copolymerizable, monoethylenically unsaturated monomers); and 0-2 mole % of an acid functional monoethylenically unsaturated monomer (preferably acid functional monoethylenically unsaturated monomers),
   wherein the sum of mole percentages does not exceed 100% and wherein the acid value of VP1 is lower or equal to 30 mg KOH/g, and
2) a vinyl polymer VP2 comprising 20-30 mole % of an acid functional monoethylenically unsaturated monomer (preferably acid functional monoethylenically unsaturated monomers), and 70-80 mole % of a hydroxyalkyl (meth)acrylate (or of hydroxyalkyl (meth)acrylates)) or a different, copolymerizable, monoethylenically unsaturated monomer (preferably different, copolymerizable, monoethylenically unsaturated monomers), or a mixture thereof,
   wherein the sum of mole percentages does not exceed 100%, the multiphase acrylic polymer being prepared by multiple step emulsion polymerization comprising at least the following subsequent steps i) and ii):
i. preparing 75-90 parts by weight (calculated on 100 parts by weight of the prepared copolymer) of vinyl polymer VP1, and subsequently
ii. preparing 10-25 parts by weight (calculated on 100 parts by weight of the prepared copolymer) of vinyl polymer VP2, in the presence of vinyl polymer VP1.

The hydroxyl number of vinyl polymer VP1 is of 100-250 mg KOH/g, preferably of 100-200 mg KOH/g, and more preferably of 100-175 mg KOH/g.

In another even more preferred embodiment, the polyacrylate dispersion comprises a multiphase acrylic polymer, said multiphase acrylic polymer comprising at least two (polymer) phases:
1) a vinyl polymer VP1 comprising 0-65 mole % of a (cyclo)alkyl (meth)acrylate (preferably (cyclo)alkyl (meth)acrylates) of which the (cyclo)alkyl group contains 4-12 carbon atoms; 15-35 mole % of hydroxyalkyl (meth)acrylate(s); 0 mole % of a different, copolymerizable, monoethylenically unsaturated monomer (preferably different, copolymerizable, monoethylenically unsaturated monomers); and 0-2 mole % of an acid functional monoethylenically unsaturated monomer (preferably acid functional monoethylenically unsaturated monomers),
   wherein the sum of mole percentages does not exceed 100% and wherein the acid value of VP1 is lower or equal to 30 mg KOH/g, and
2) a vinyl polymer VP2 comprising 20-30 mole % of an acid functional monoethylenically unsaturated monomer (preferably acid functional monoethylenically unsaturated monomers), and 70-80 mole % of a hydroxyalkyl (meth)acrylate (or hydroxyalkyl (meth)acrylates) or a different, copolymerizable, monoethylenically unsaturated monomer (preferably different, copolymerizable, monoethylenically unsaturated monomers), or a mixture thereof,
   wherein the sum of mole percentages does not exceed 100%,
the multiphase acrylic polymer being prepared by multiple step emulsion polymerization comprising at least the following subsequent steps i) and ii):
i. preparing 75-90 parts by weight (calculated on 100 parts by weight of the prepared copolymer) of vinyl polymer VP1, and subsequently
ii. preparing 10-25 parts by weight (calculated on 100 parts by weight of the prepared copolymer) of vinyl polymer VP2, in the presence of vinyl polymer VP1.

The hydroxyl number of vinyl polymer VP1 is of 100-250 mg KOH/g, preferably of 100-200 mg KOH/g, and more preferably of 100-175 mg KOH/g.

In an alternative most preferred embodiment, the polyacrylate dispersion comprises a multiphase acrylic polymer, said multiphase acrylic polymer comprising at least two (polymer) phases:
1) a vinyl polymer VP1 comprising 0-75 mole % of a (cyclo)alkyl (meth)acrylate (preferably (cyclo)alkyl (meth)acrylates) of which the (cyclo)alkyl group contains 4-12 carbon atoms; 20-30 mole % of hydroxyalkyl (meth)acrylate(s); 0 mole % of a different, copolymerizable, monoethylenically unsaturated monomer (preferably different, copolymerizable, monoethylenically unsaturated monomers); and 0-2 mole % of an acid functional monoethylenically unsaturated monomer (preferably acid functional monoethylenically unsaturated monomers),
   wherein the sum of mole percentages does not exceed 100% and wherein the acid value of VP1 is lower or equal to 30 mg KOH/g, and
2) a vinyl polymer VP2 comprising 20-30 mole % of an acid functional monoethylenically unsaturated monomer (preferably acid functional monoethylenically unsaturated monomers), and 70-80 mole % of a hydroxyalkyl (meth)acrylate (or of hydroxyalkyl (meth)acrylates) or a different, copolymerizable, monoethylenically unsaturated monomer (preferably different, copolymerizable, monoethylenically unsaturated monomers), or a mixture thereof,
   wherein the sum of mole percentages does not exceed 100%,
the multiphase acrylic polymer being prepared by multiple step emulsion polymerization comprising at least the following subsequent steps i) and ii):
i. preparing 75-90 parts by weight (calculated on 100 parts by weight of the prepared copolymer) of vinyl polymer VP1, and subsequently
ii. preparing 10-25 parts by weight (calculated on 100 parts by weight of the prepared copolymer) of vinyl polymer VP2, in the presence of vinyl polymer VP1.

The hydroxyl number of vinyl polymer VP1 is of 100-250 mg KOH/g, preferably of 100-200 mg KOH/g, and more preferably of 100-175 mg KOH/g.

The invention further relates to an aqueous coating composition comprising:
from 0.1 to 100 wt % of the polyacrylate dispersion (“PAD”) of the invention (as described here above), preferably from 0.1 to 50 wt %,
optionally, from 0.1 to 50 wt % of a polyurethane dispersion (“PUD”), and/or
optionally, from 0.1 to 15 wt % of a crosslinker C,
   based on the sum of PAD, and, if present, PUD and crosslinker C (i.e. the sum of the weight percentages adding up to 100 wt %).

Preferably, the aqueous coating composition comprises from 0.1 to 50 wt % polyurethane dispersion PUD. More preferably, the polyurethane dispersion has a OH value of at least 35 mg KOH/g (solid matter content), even more preferably the polyurethane dispersion comprises at least:
a polyurethane U1 having a weight-average molar mass Mw1 of at least 10 kg/mole, and
a polyurethane U2 having a weight-average molar mass Mw2 of less than 10 kg/mole,
   the weight-average molar mass being determined by size exclusion chromatography in tetrahydrofuran, relative to polystyrene standards, and the polyurethane U2 further having:
a specific amount of substance, in accordance with DIN 32 625, of hydroxyl groups n(—OH)/m(U2) of from 1.4 mole/kg to 4 mole/kg,
a degree of branching, in accordance with DIN 32 625, of up to 0.5 mole/kg, and
a specific amount of substance, in accordance with DIN 32 625, of urea groups n(—NH—CO—NH—)/m(U2) of from 0.8 mole/kg to 2 mole/kg.

In the context of the present description, the OH value of the polyurethane dispersion PUD can be determined (in mg KOH/g) according to DIN EN ISO 4629 (DIN 53240).

Likewise, the acid value of the polyurethane dispersion PUD can be determined (in mg KOH/g) according to DIN EN ISO 3682 (DIN 53402).

In the context of the present description, coating composition is also referred to as coating formulation or formulation.

Applicants have found that the use of such polyacrylate dispersion and aqueous coating composition allows to obtain (metallic) base coats in a base coat/clear coat system, providing a coating system combining good overall coating properties with good (or even high) flop and gloss. More specifically, it was surprisingly found that use of the polyacrylate dispersion and aqueous coating composition of the invention provides coating systems with excellent chemical resistance, without compromising on gloss and flop. Furthermore, use of the high OH-functional waterborne (or aqueous) polyacrylate dispersion provides good performance when used in formulating aqueous base coat compositions, especially for automotive metal and plastic parts. It is particularly surprising that the adhesion to plastics (even without a primer) and the intercoat adhesion (e.g. between the base coat and a next clear coat) is improved using the high OH-functional waterborne (or aqueous) polyacrylate dispersion for base coat compositions (compared to base coats used in the art).

In the context of the present description, “flop” refers to a differential light reflection effect of a metallic color (or of a coat having a metallic appearance), depending on the viewing angle. The flop index is the measurement on the change in reflectance of a metallic color (of a coat having a metallic appearance) as it is rotated through the range of viewing angles. A flop index of 0 indicates a solid color, while a high flop metallic or pearlescent base coat/clear coat color may have a flop index of 15-17. The flop-index can be measured with a multi-angle spectrophotometer that is designed for measuring color on metallic and pearlescent paint finishes.

Molar masses of polymeric substances and weighted averages thereof, including number-average molar mass (Mn) and weight-average molar mass (Mw), have been determined on solutions in tetrahydrofuran by size exclusion chromatography, also referred to as gel permeation chromatography, using polystyrene standards (according to ASTM D3593).

In a preferred embodiment, polyurethane U1 in the polyurethane dispersion has a weight-average molar mass Mw1 of at least 10 kg/mole, preferably at least 15 kg/mole, and particularly preferred, at least 20 kg/mole. It has preferably an acid number of from 8 mg KOH/g to 40 mg KOH/g, more preferred, from 12 mg KOH/g to 30 mg KOH/g, and a hydroxyl number of from 0 mg KOH/g to 50 mg KOH/g, more preferred from 2 mg KOH/g to 30 mg KOH/g. Polyurethane U2 has a weight-average molar mass Mw2 of less than 10 kg/mole, preferably less than 8 kg/mole, a specific amount of substance of hydroxyl groups n(—OH)/m(U2) of the polyurethane polymer U2 of from 1.4 mole/kg to 4 mole/kg. It has further a degree of branching of up to 0.5 mole/kg, preferably from 0.2 mole/kg to 0.33 mole/kg, and a specific amount of substance of urea groups n(—NH—CO—NH—)/m (U2) of from 0.8 mole/kg to 2.0 mole/kg, preferably from 1.0 mole/kg to 1.8 mole/kg.

For all parameters which relate to the ratio b(X) of the amount of substance n(X), for a particular chemical group X (such as degree of branching, urea groups, acid groups, acid anion groups, or hydroxyl groups), to the mass of the resin m(Resin), said ratio being defined by b(X)=n(X)/m(Resin) and also referred to as the specific amount of substance b(X) in accordance with DIN 32 625, m(Resin) is the mass of the polyurethane under consideration.

Depending on the desired application, the polyurethane dispersion can be (poly)carbonate, polyether or (poly)ester based, or a polyurethane-acrylic hybrid.

Preferably, the polyurethane dispersion in the aqueous coating composition is a (poly)carbonate based polyurethane dispersion, more preferably a (poly)carbonate based polyurethane dispersion with high OH value (the OH value of the (poly)carbonate based polyurethane dispersion can be determined (in mg KOH/g) according to DIN EN ISO 4629 (DIN 53240)).

Preferably, the polyisocyanate crosslinker C in the aqueous coating composition is selected from the group consisting of polyisocyanates, blocked polyisocyanates, amino-formaldehyde resins (such as ureum-formaldehyde resins or melamine-formaldehyde resins) and formaldehyde free based resins, and mixtures of amino resins with (blocked) polyisocyanates.

Melamine-formaldehyde resins are very well known in the art and have been commercialized since long, and may be obtained from allnex under the tradenames of CYMEL® and SETAMINE®. These melamine-formaldehyde resins, optionally in solution in corresponding organic solvents, comprise products with various degrees of methylolation, degrees of etherification or degrees of condensation (monocyclic or polycyclic). Preferred melamine-formaldehyde resins are those sold under the tradenames of CYMEL® 202, CYMEL® 232, CYMEL® 235, CYMEL® 238, CYMEL® 254, CYMEL® 266, CYMEL® 267, CYMEL® 272, CYMEL® 285, CYMEL® 301, CYMEL® 303, CYMEL® 325, CYMEL 327, CYMEL® 350, CYMEL® 370, CYMEL® 701, CYMEL® 703, CYMEL® 736, CYMEL® 738, CYMEL® 771, CYMEL® 1141, CYMEL® 1156, CYMEL® 1158, CYMEL® 1168, CYMEL® NF 2000, CYMEL® NF 2000A, SETAMINE® US-132 BB-71, SETAMINE® US-134 BB-57, SETAMINE® US-138 BB-70, SETAMINER® US-144 BB-60, SETAMINER® US-146 BB-72, SETAMINE® US-148 BB-70, or mixtures thereof. Particularly preferred are SETAMINE® US-138 BB-70, CYMEL® 327, CYMEL® NF 2000, CYMEL® NF 2000A, or mixtures thereof. Formaldehyde-free crosslinking agents such as CYMEL® NF 3030 and CYMEL® NF 3041 can also be used.

Crosslinker component C preferably comprises a polyisocyanate compound with at least two free —NCO (isocyanate) groups. Polyisocyanate crosslinkers are well known and have extensively been described in the art. The polyisocyanate compound is usually selected from the group consisting of aliphatic, cycloaliphatic, and/or aromatic polyisocyanates comprising at least two —NCO groups and mixtures thereof. The crosslinker C can be a diisocyanate, more preferably selected from the group consisting of hexamethylene diisocyanate, 2,4,4-trimethyl hexamethylene diisocyanate, 1,2-cyclohexylene diisocyanate, 1,4-cyclohexylene diisocyanate, 4,4′-dicyclohexylene diisocyanate methane, 3,3′-dimethyl-4,4′-dicyclohexylene diisocyanate methane, norbornane diisocyanate, m-and p-phenylene diisocyanate, 1,3- and 1,4-bis (isocyanate methyl) benzene, xylylene diisocyanate, α,α,α′,α′-tetramethyl xylylene diisocyanate (TMXDI), 1,5-dimethyl-2,4-bis (isocyanate methyl) benzene, 2,4- and 2,6-toluene diisocyanate, 2,4,6-toluene triisocyanate, 4,4′-diphenylene diisocyanate methane, 4,4′-diphenylene diisocyanate, naphthalene-1,5-diisocyanate, isophorone diisocyanate, 4-isocyanatomethyl-1,8-octamethylene diisocyanate, and mixtures of the aforementioned polyisocyanates. Other isocyanate crosslinkers are (the condensed) derivatives of diisocyanates, such as biurets, isocyanurates, imino-oxadiazinediones, allophanates, uretdiones, and mixtures thereof. Examples of such adducts are the adduct of two molecules of hexamethylene diisocyanate or isophorone diisocyanate to a diol such as ethylene glycol, the adduct of 3 molecules of hexamethylene diisocyanate to 1 molecule of water, the adduct of 1 molecule of trimethylol propane to 3 molecules of isophorone diisocyanate, the adduct of 1 molecule of pentaerythritol to 4 molecules of toluene diisocyanate, the isocyanurate of hexamethylene diisocyanate (e.g. available under the trade names DESMODUR® (E) N3390, TOLONATE® HDT-LV, TOLONATE® HDT-90 or DESMODUR® ultra 2822), the biuret of hexamethylene diisocyanate, under the trade name DESMODUR® N 75, a mixture of the uretdione and the isocyanurate of hexamethylene diisocyanate, under the trade name DESMODUR® N3400, the allophanate of hexamethylene diisocyanate, available under the trade name DESMODUR® LS 2101, and the isocyanurate of isophorone diisocyanate, available under the trade name VESTANAT® T1890. Furthermore, (co)polymers of isocyanate-functional monomers such as α,α′-dimethyl-m-isopropenyl benzyl isocyanate are suitable for use. If desired, it is also possible to use hydrophobically or hydrophilically modified polyisocyanates to impart specific properties to the coating.

Crosslinker C can also comprise blocked polyisocyanates when blocking agents having a sufficiently low deblocking temperature they can be used to block any of the polyisocyanate crosslinker C mentioned above. In that case, crosslinker C is substantially free of unblocked isocyanate group-containing compounds and the crosslinkable composition can be formulated as one-component formulation. The blocking agents which can be used to prepare a blocked isocyanate component are well-known to the skilled worker.

In a preferred embodiment, crosslinker C is a polyisocyanate crosslinker.

In the aqueous coating composition of the invention, a suitable amount of crosslinker C can depend, among others, on the percentage of OH-functional monomer present, and will be apparent to those skilled in the art.

Crosslinking temperature (curing temperature) depends on the desired application and substrate used, and will be apparent to those skilled in the art. Crosslinking temperature can vary for example from ambient temperature to about 180° C.

Preferably, in the polyurethane dispersion PUD, the mass fraction w(U2) of the polyurethane U2 is between 0.50 kg/kg and 0.80 kg/kg, the mass fraction w(U2) being defined as the ratio of the mass m(U2) of polyurethane U2 to the sum of the masses m(U1) and m(U2) of polyurethanes U1 and U2, i.e. w(U2)=m(U2)/[m(U1)+m(U2)].

Preferably, at least one of the polyurethanes U1 and U2 in the polyurethane dispersion PUD has a specific amount of substance of acid and/or acid anion groups of from 0.1 mole/kg to 1.8 mole/kg.

The solids content of the aqueous composition of the invention is preferably within the range of from 5 to 40 weight %, more preferably within the range of from 5 to 20 weight % (based on the total weight of the composition). In aspects of the invention, a suitable solids content depends on the desired paint application and will be apparent for those skilled in the art.

The coating composition of the invention may further comprise at least one or more conventional ingredients selected from the group consisting of non-vinyl polymers, pigments, dyes, emulsifiers, surfactants, plasticizers, thickeners, heat stabilizers, levelling agents, anti-cratering agents, fillers, sedimentation inhibitors, UV absorbers, antioxidants, organic co-solvents, wetting agents and the like, and mixtures thereof.

The coating composition according to an embodiment of the invention preferably comprises:
from 0.1 to 50 wt % of polyacrylate dispersion PAD;
from 0.1 to 50 wt % of polyurethane dispersion PUD;
from 0.1 to 1 wt % of pigment dispersing additive (or pigment wetting additive);
from 2 to 8 wt % of pigment;
from 0 to 6 wt % of thickener;
from 0.1 to 1 wt % of surface wetting additive (or surfactant);
from 0.1 to 1 wt % of flow or leveling additive;
from 0 to 5 wt % of metallic pigment leveling additive; and
from 0.1 to 15 wt % of crosslinker C,
   the sum of the weight percentages adding up to 100 wt %.

Non-limiting examples of thickener that can be used are silicate thickener, acrylic thickener, polyurethane thickener, and/or cellulose thickener. Preferably, if present, a silicate thickener and/or acrylic thickener is used.

Pigments can be inorganic (metallic) pigments or organic pigments. Non-limiting examples of suitable inorganic pigments are aluminum based pigments, iron oxide pigments, titanium oxide pigments, zinc oxide pigments, chromium oxide pigments co-precipitated with nickel and nickel titanates, yellow pigments from lead sulphochromate or lead bismuth vanadate, orange pigments from lead sulphochromate molybdate, and carbon black. Non-limiting examples of suitable organic pigments are azo pigments, metal complex pigments, anthraquinonoid pigments, phthalocyanine pigments, polycyclic pigments, especially those of the thioindigo, quinacridone, dioxazine, pyrrolo, naphthalenetetracarboxylic acid, perylene, isoamidolin(on)e, flavanthrone, pyranthrone, or isoviolanthrone series. Preferably, metallic pigments are used.

The coating composition according to an embodiment of the invention more preferably comprises:
from 0.1 to 50 wt % of polyacrylate dispersion PAD;
from 0.1 to 50 wt % of polyurethane dispersion PUD;
from 0.1 to 1 wt % of pigment dispersing additive (or pigment wetting additive);
from 2 to 8 wt % of metallic pigment;
from 0 to 6 wt % of (layered) silicate thickener;
from 0 to 6 wt % of acrylic thickener;
from 0.1 to 1 wt % of surface wetting additive (or surfactant);
from 0.1 to 1 wt % of flow or leveling additive;
from 0 to 5 wt % of metallic pigment leveling additive; and
from 0.1 to 15 wt % of crosslinker C,
   the sum of the weight percentages adding up to 100 wt %.

The present invention also refers to a method of making a coating composition comprising the step of blending the polyacrylate dispersion PAD of the invention with at least one or more conventional ingredients selected from the group consisting of non-vinyl polymers, pigments, dyes, emulsifiers, surfactants, plasticizers, thickeners, heat stabilizers, levelling agents, anti-cratering agents, fillers, sedimentation inhibitors, UV absorbers, antioxidants, organic co-solvents, wetting agents and the like, and mixtures thereof.

The aqueous coating composition of the invention can be applied to any substrate. The substrate may be, for example, metal, e.g., iron, steel, pretreated steel types such as electrocoated, zinc (galvanized), and phosphated steel, tinplate, aluminium substrates including chrome treated and non-chrome treated aluminium or alloys, plastic, wooden substrates or wood composites, board, paper, cardboard, leather, synthetic material, glass and mineral substrates such as concrete, tiles, stone and plaster. Other materials suitable as substrates for the coating composition of the invention are heat sensitive substrates such as plastic substrates, especially ABS substrates, polycarbonate substrates, ABS/polycarbonate substrates, glass- and carbon-fiber reinforced plastics or composites, SMC (sheet molding compound) such a polyester and glass fiber combinations, especially those used in automotive applications, poly(ethylene terephthalate), poly(butylene terephthalate), polyamide-6, polyamide-6.6, (thermoplastic) polyolefins, poly(vinyl chloride), poly(methyl methacrylate) and polystyrene. The coating composition of the invention can also be applied on coated substrates, including metal, plastic, mineral or wood substrates pretreated with e.g. sealer, primer, putty, water-borne or solvent-borne basecoat layers. The coating composition of the invention can furthermore be applied onto metal, wooden or mineral substrates pretreated with adhesion-promoting substances such as (amino)silanes. The coating system may also be applied on multi-substrate assemblies composed of metal and/or plastic parts with various different pretreatments and/or coatings including those mentioned above.

The aqueous coating composition of the invention can thus be applied to another coating layer as well. The other coating layer can comprise the coating composition of the current invention or it can be a different coating composition such as a solvent borne or water borne base coat or a primer, preferably a base coat. The primer can be any primer, but those skilled in the art know that often epoxy based or polyurethane based primers are often used in various fields of application. The coating compositions of the current invention show particular utility as clear coats, base coats, pigmented top coats, primers, and fillers.

The aqueous coating composition according to the invention is very suitable for use as a clear coat for Vehicle Refinishes or Automotive OEM. A clear coat is essentially free of pigments and is transparent for visible light. However, the clear coat composition may comprise matting agents, for example silica based matting agents, to control the gloss level of the coating.

When the aqueous coating composition of the invention is a clear coat, it is preferably applied over a color- and/or effect-imparting base coat. In that case, the clear coat forms the top layer of a multi-layer lacquer coating such as typically applied on the exterior or interior of automobiles. The base coat may be a water borne base coat or a solvent borne base coat. The aqueous coating composition of the current invention is also suitable as pigmented topcoat for Protective Coatings to coat objects such as bridges, pipelines, industrial plants or buildings, oil and gas installations, or ships. The compositions are particularly suitable for finishing and refinishing automobiles and large transportation vehicles, such as trains, trucks, buses, and airplanes. Also, the aqueous coating composition of the current invention can be used in flooring applications. In general, the aqueous coating composition of the current invention can be applied by spraying, brushing, draw-down, pouring, casting, overspray-free paint applications based on jet-stream or drop-on-demand technology, or any other method to transfer a composition to a substrate.

The polyacrylate dispersion and aqueous coating composition according to preferred aspects of the present invention can be used in one pack or two pack aqueous coating compositions that are used as basecoats for (primerless) plastic and automotive application (both interior and exterior applications). The polyacrylate dispersion and aqueous coating composition are particularly useful in formulating aqueous base coat compositions for, for example, vehicle refinishes, for automotive OEM, for transportation vehicles (automobiles and large transportation vehicles, such as trains, trucks, buses, and airplanes), and for general industry applications, more particularly for metallic coatings on (primerless) plastics and on metal for automotive OEM. Therefore, the invention also relates to a method of use of the coating composition of the present invention, to form a coating layer for the refinishing of cars and the finishing of trucks, buses, trains, aero planes and cars, preferably to form metallic coatings on metals and plastics for automotive OEM.

The invention also relates to a metal or plastic substrate, preferably a plastic substrate, more preferably a plastic substrate of automobiles and large transportation vehicles, coated with the aqueous coating composition of the invention.

With the present invention, it was surprisingly found that the polyacrylate dispersion of the invention is particularly suitable to formulate aqueous coating compositions, preferably base coat compositions. Metallic basecoats are obtained combining very good chemical resistance with good (to high) flop and gloss and other properties as well as, such as good adhesion to plastics, hardness, water resistance, making them particularly suitable for automotive applications. Moreover, the present invention is more environment friendly, as use of e.g. chlorinated polyolefins (known in the art to provide good adhesion properties) is avoided. The invention will be explained in more detail by the following, non-limiting examples.

### EXAMPLES

### Test Methods

### Solids Content (SC)

The solids content (SC) is measured by weighing 1 gram of dispersion in a tin-cup and putting the cup into an air circulated oven for 60 minutes at 125° C. The difference in weight, measured after weighing the cup coming out of the oven, relates to the volatile content and the remaining non-volatile part is the solids content. If the viscosity is high, 1 gram of water is added before heating.

### Acid Value (AV, or Acid Number)

Theoretical (or calculated) AV of vinyl polymer VP1, vinyl polymer VP2, and multiphase acrylic polymer is given in the experiments, not taking into account the presence of impurities. The theoretical acid value is calculated by Eq. (I) (vide supra).

### Hydroxyl Value (OHV, OH Value, or Hydroxyl Number)

Theoretical (or calculated) OHV of vinyl polymer VP1, vinyl polymer VP2, and multiphase acrylic polymer is given in the experiments, not taking into account the presence of impurities (and of neutralization agents, if present). The theoretical hydroxyl value is calculated by Eq. (II) (or by Eq. (II′)) (vide supra).

### Hardness

Pendulum hardness according to the König method was measured (in seconds) in accordance with ASTM D 2457; 100 μm wet applied on glass, dried at room temperature and 16h at 50° C.

### Flop Index

Flop index was measured according to ASTM Standard E 2194-03, Multiangle Color Measurement of metal Flake Pigmented Materials.

### Chemical Resistance against Hand Cream and Sun Tan Lotion

Chemical resistance against a test hand cream (test cream according to Volkswagen (VW) AG test PV 3964, Type A, available from Thierry GmbH, Stuttgart) and a test sun cream (or sun lotion) (test lotion according to Volkswagen AG test PV 3964, Type B, available from Thierry GmbH, Stuttgart) on a plastic substrate including PC (polycarbonate) and ABS (acrylonitrile-butadiene-styrene), more particularly on BAYBLEND® T65 XF, a blend of PC and ABS, was tested. Tests were performed by impregnating a gauze strip having an area of 1 cm² with cream or lotion, removing the excess cream or lotion with a spatula, positioning this gauze strip onto a painted surface of the substrate (i.e. the surface of the substrate onto which a coating formulation is applied on), covering the substrate and strip with a plastic cap, and heating in an oven at 80° C. for twenty-four hours. Adhesion was tested on these samples by the cross hatch test with tape pull off according to DIN EN ISO 2409, “0”=best (no loss of adhesion), 5=worst (whole cross-hatched area is loose). In addition, scratch resistance (in Newton) is tested with an Erichsen 318 type pen with a 0.75 mm tip.

### Chemical Resistance against a Sunscreen/Insect Repellent

Chemical resistance against a sunscreen/insect repellent (test liquid according to GM GMW14445 test standard, available from Thierry GmbH, Stuttgart) on a plastic substrate including PC and ABS, more particularly on BAYBLEND® T65 XF, a blend of PC and ABS, was tested. Tests were performed by dropping approximately 50 μl of the test liquid to the clean surface of the test sample on at least three different spots using a pipette. The test sample is placed into an oven for 1 hour at 80° C.+/−3° C. Immediately after removing from the oven, the test sample is cleaned with a detergent solution and wiped dry. After cooling down to room temperature (23° C.+/−5° C.) the evaluation is carried out by rating the tested spot from 1 (no change) to 4 (very significant change of color, swelling, blisters, creases or other non-tolerable effects). In order to pass the test, the coating should be rated 1 (no change of color, swelling, blisters, creases or other defects).

### Humidity Resistance

Hydrolysis ageing according Volkswagen standard TL 226 was done in a humidity chamber for 72 hours at 90+/−2° C. and >96% rel. hum. Prior to the evaluation the test panels are conditioned at room temperature for 4 hours after the test. In order to pass the test, no optical changes or a loss of adhesion after the hydrolysis ageing and subsequent conditioning at room temperature is allowed.

### Gloss

After cooling to room temperature, the gloss of a coating (at 60° angle) was measured with a Byk-Gardner Micro Gloss meter in accordance with DIN EN ISO 2813.

### Chemical Resistance against Solvents

Acetone and Xylene resistance was determined according to internal test standard VLN 154. More specifically, a piece of cotton is soaked into the solvent and placed onto the tested surface (coated glass sheet). Each 30 seconds, swelling and softening is tested with a wooden spatula. Evaporating solvent is constantly added onto the cotton with a pipette. The test is stopped once the surface is completely dissolved.

### Examples 1 to 6 and Comparative Examples 1 and 2

### Preparation of Polyacrylate Dispersions

Ingredients and weights (in parts) are given in Table 2a. The procedure followed for each of the examples is given in more detail below as well, referring to this table (and referring to the ingredients given in Table 2a as components).

TABLE 2a

| | | Ex. 1 | Ex. 2 | Ex. 3 | Ex. 4 | Ex. 5 | Ex. 6 | CEx. 1 | CEx. 2 |
|---|---|---|---|---|---|---|---|---|---|
| No. | Ingredients (components) | Parts | Parts | Parts | Parts | Parts | Parts | Parts | Parts |
| 1 | Demi water | 35.98 | 35.98 | 35.98 | 35.98 | 35.99 | 35.94 | 30.75 | 35.89 |
| 2 | Adeka Reasoap ® SR-1025 | 0.30 | 0.30 | 0.30 | 0.30 | 0.30 | 0.30 | 0.00 | 0.30 |
| 3 | ABEX ® EP 110 | 0.00 | 0.00 | 0.00 | 0.00 | 0.00 | 0.00 | 0.17 | 0.00 |
| 4 | Sodium Persulfate | 0.03 | 0.03 | 0.03 | 0.03 | 0.03 | 0.03 | 0.03 | 0.03 |
| 5 | Demi water | 0.26 | 0.26 | 0.26 | 0.26 | 0.26 | 0.26 | 0.27 | 0.23 |
| 6 | Adeka Reasoap ® SR-1025 | 0.34 | 0.34 | 0.34 | 0.34 | 0.34 | 0.34 | 0.00 | 0.34 |
| 7 | ABEX ® EP 110 | 0.00 | 0.00 | 0.00 | 0.00 | 0.00 | 0.00 | 0.27 | 0.00 |
| 8 | Demi water | 7.91 | 7.91 | 7.91 | 7.91 | 7.91 | 7.90 | 3.71 | 3.62 |
| 9 | Methacrylic acid | 0.00 | 0.00 | 0.00 | 0.00 | 0.00 | 0.00 | 0.03 | 0.00 |
| 10 | n-Butyl methacrylate | 8.32 | 9.16 | 10.55 | 10.60 | 5.46 | 10.54 | 14.21 | 9.69 |
| 11 | Acrylamide (30% in water) | 0.00 | 0.00 | 0.00 | 0.00 | 0.00 | 0.00 | 3.18 | 3.19 |
| 12 | Styrene | 0.00 | 0.00 | 0.00 | 0.00 | 0.00 | 0.00 | 0.00 | 1.15 |
| 13 | 2-Hydroxyethyl methacrylate | 7.94 | 7.10 | 5.71 | 0.00 | 5.71 | 5.71 | 1.29 | 0.98 |
| 14 | 4-Hydroxybutyl acrylate | 0.00 | 0.00 | 0.00 | 5.66 | 0.00 | 0.00 | 0.00 | 0.00 |
| 15 | Methyl methacrylate | 0.00 | 0.00 | 0.00 | 0.00 | 2.96 | 0.00 | 0.00 | 0.44 |
| 16 | Allyl methacrylate | 0.00 | 0.00 | 0.00 | 0.00 | 0.00 | 0.10 | 0.00 | 0.00 |
| 17 | n-Butyl acrylate | 4.72 | 4.72 | 4.72 | 4.72 | 6.83 | 4.71 | 4.53 | 6.10 |
| 18 | 2-hydroxyethyl methacrylate | 0.00 | 0.00 | 0.00 | 0.00 | 0.00 | 0.00 | 0.00 | 0.77 |
| 19 | Demi water (rinse) | 0.64 | 0.64 | 0.64 | 0.64 | 0.64 | 0.63 | 0.64 | 0.64 |
| 20 | Demi water | 0.00 | 0.00 | 0.00 | 0.00 | 0.00 | 0.00 | 7.00 | 5.55 |
| 21 | Ammonium persulfate | 0.00 | 0.00 | 0.00 | 0.00 | 0.00 | 0.00 | 0.03 | 0.01 |
| 22 | Methacrylic acid | 0.53 | 0.53 | 0.53 | 0.53 | 0.53 | 0.53 | 0.53 | 0.70 |
| 23 | n-Butyl acrylate | 1.14 | 1.14 | 1.14 | 1.14 | 1.14 | 1.14 | 1.14 | 1.51 |
| 24 | 2-Hydroxyethyl acrylate | 0.75 | 0.75 | 0.75 | 0.75 | 0.75 | 0.75 | 0.75 | 0.99 |
| 25 | Methyl methacrylate | 0.53 | 0.53 | 0.53 | 0.53 | 0.53 | 0.53 | 0.53 | 0.70 |
| 26 | Demi water (rinse) | 2.11 | 2.11 | 2.11 | 2.11 | 2.11 | 2.55 | 2.12 | 2.12 |
| 27 | Demi water | 5.27 | 5.27 | 5.27 | 5.27 | 5.27 | 5.26 | 5.28 | 7.01 |
| 28 | Ammonium persulfate | 0.01 | 0.01 | 0.01 | 0.01 | 0.01 | 0.01 | 0.01 | 0.03 |
| 29 | Demi water | 22.37 | 22.37 | 22.37 | 22.37 | 22.38 | 21.92 | 22.69 | 22.72 |
| 30 | 2-(Dimethylamino)ethanol | 0.21 | 0.21 | 0.21 | 0.21 | 0.21 | 0.21 | 0.21 | 0.21 |
| 31 | Demi water | 0.64 | 0.64 | 0.64 | 0.64 | 0.64 | 0.63 | 0.64 | 0.64 |

In Table 2b, the theoretical (i.e. calculated) OH value (OHV) of VP1, VP2 and of the multiphase acrylic polymer is given.

TABLE 2b

| | OHV (mg KOH/g) | | | | | | | |
|---|---|---|---|---|---|---|---|---|
| | Ex. | Ex. | Ex. | Ex. | Ex. | Ex. | CEx. | CEx. |
| | 1 | 2 | 3 | 4 | 5 | 6 | 1 | 2 |
| VP1 | 163 | 146 | 117 | 105 | 117 | 117 | 24 | 20 |
| VP2 | 123 | 123 | 123 | 123 | 123 | 123 | 123 | 123 |
| Multiphase | 156 | 141 | 116 | 105 | 116 | 116 | 38 | 50 |
| polymer | | | | | | | | |

### Procedure Example 1

Components 6 to 18 were charged to a monomer mix tank and stirred with a pitched blade impeller until a stable pre-emulsion was obtained. A 3 L reactor, equipped with condenser, nitrogen inlet, PT100 probe, pitched blade impeller and inlet for monomer and initiator, was charged with components 1 and 2 and heated to 70° C. under a nitrogen atmosphere. Seed particles were prepared by loading 5 wt % of the monomer mix tank contents to the reactor and subsequent addition of a mixture of components 4 and 5. The exotherm of the reaction was used for 15 minutes to heat the reactor further to 85° C. When the reactor contents had reached 85° C., the remainder of the monomer mix tank was added to the reactor over a period of 1 hour. After the addition of monomers was finished, the monomer mix tank was rinsed with component 19 and the reactor was held at 85° C. for 0.75 hours. For the next stage, components 22 to 25 were loaded to the monomer mix tank and subsequently added to the reactor over a period of 0.75 hours. Simultaneously, one third of a mixture of components 27 and 28 was added. After the addition of the second stage monomers was finished, the monomer mix tank was rinsed with component 26 and the batch was kept at 85° C. for 2 hours. During this two hour post-cook, the remainder of the mixture of components 27 and 28 was added to the reactor over a period of 0.5 hours. After the post-cook time had passed, the reactor contents were cooled to 23° C. At 23° C., a mixture of components 29 and 30 was added to the reactor over a period of 0.5 hours, followed by component 31. The obtained multistage dispersion had a solids content of 24%, a (calculated) acid value of 14 mg KOH/g solid resin and a (calculated) hydroxyl value of 156 mg KOH/g solid resin.

### Procedure Example 2

Example 1 was repeated using a different amount of hydroxyl monomer in the preparation of vinyl polymer VP1. The obtained multistage dispersion had a solids content of 24%, a (calculated) acid value of 14 mg KOH/g solid resin and a (calculated) hydroxyl value of 141 mg KOH/g solid resin.

### Procedure Example 3

Example 2 was repeated using a different amount of hydroxyl monomer in the preparation of vinyl polymer VP1. The obtained multistage dispersion had a solids content of 24%, a (calculated) acid value of 14 mg KOH/g solid resin and a (calculated) hydroxyl value of 116 mg KOH/g solid resin.

### Procedure Example 4

Example 1 was repeated using a different type of hydroxyl monomer in the preparation of vinyl polymer VP1. The obtained multistage dispersion had a solids content of 24%, a (calculated) acid value of 14 mg KOH/g solid resin and a (calculated) hydroxyl value of 105 mg KOH/g solid resin.

### Procedure Example 5

Example 1 was repeated using a different amount of C4 alkyl (meth)acrylate monomers and further adding a different, copolymerizable, monoethylenically unsaturated monomer in the preparation of vinyl polymer VP1. The obtained multistage dispersion had a solids content of 24%, a (calculated) acid value of 14 mg KOH/g solid resin and a (calculated) hydroxyl value of 116 mg KOH/g solid resin.

### Procedure Example 6

Example 1 was repeated, now further adding a cross-linker in the preparation of vinyl polymer VP1. The obtained multistage dispersion had a solids content of 24%, a (calculated) acid value of 14 mg KOH/g solid resin and a (calculated) hydroxyl value of 116 mg KOH/g solid resin.

### Procedure Comparative Example 1

A 3 L reactor, equipped with condenser, nitrogen inlet, PT100 probe, pitched blade impeller and inlet for monomer and initiator, was charged with components 1 and 3 and heated to 70° C. under nitrogen atmosphere. Seed particles were prepared by loading a mixture of component 9, 4% of component 10 and 4% of component 17 into the reactor. Subsequently, a mixture of components 4 and 5 was added to the reactor, and the resulting exothermic reaction was used for 15 minutes to heat the reactor further to 85° C. The remainder (96%) of component 10 and 17, components 11 to 13, and components 7 and 8 were charged to a monomer mix tank and stirred until a stable pre-emulsion was obtained. When the reactor contents had reached 85° C., the contents of the monomer mix tank and a mixture of components 20 and 21 were added simultaneously to the reactor over a period of 3 hours. After the addition of monomers was finished, the monomer mix tank was rinsed with component 19 and the reactor was cooled to 80° C. The batch was kept at this temperature for another 0.5 hours. For the next stage, components 22 to 25 were loaded to the monomer mix tank and subsequently added to the reactor over a period of 0.5 hours. Simultaneously, a mixture of components 27 and 28 was added to the reactor over a period of 2.25 hours. After the addition of the second stage monomers was finished, the monomer mix tank was rinsed with component 26 and the batch was kept at 80° C. for 2 hours. Consequently, the dosing of the mixture of components 27 and 28 was finished 0.25 hours before the end of this aging step. After the post-cook time had passed, the reactor contents was cooled to 23° C. When the temperature was reached, a mixture of components 29 and 30 was added to the reactor over a period of 0.5 hours, followed by component 31. The obtained multistage dispersion had a solids content of 24%, a (calculated) acid value of 15 mg KOH/g solid resin and a (calculated) hydroxyl value of 38 mg KOH/g solid resin.

### Procedure Comparative Example 2

Components 6 to 11, 13 and 17 were charged to a monomer mix tank and stirred with a pitched blade impeller until a stable pre-emulsion was obtained. A 3 L reactor, equipped with condenser, nitrogen inlet, PT100 probe, pitched blade impeller and inlet for monomer and initiator, was charged with components 1 and 2 and heated to 70° C. under nitrogen atmosphere. Seed particles were prepared by loading 5 wt % of the contents of the monomer mix tank to the reactor and subsequently a mixture of components 4 and 5 was added to the reactor. The exotherm of the reaction was used for 15 minutes to heat the reactor further to 85° C. When the reactor contents had reached 85° C., a mixture of components 20 and 21 was added to the reactor over a period of 3 hours. Simultaneously, the contents of the monomer mix tank was added to the reactor over a period of 2.6 hours. After the addition of monomers was finished, the monomer mix tank was charged with the monomers of the second stage, component 12, 15 and 18, and added to the reactor over a period of 0.4 hours. After the addition of monomers was finished, the monomer mix tank was rinsed with component 19 and the reactor was cooled to 80° C. The batch was kept at this temperature for another 0.5 hours. For the next stage, components 22 to 25 were loaded to the monomer mix tank and subsequently added to the reactor over a period of 0.5 hours. Simultaneously, a mixture of components 27 and 28 was added to the reactor over a period of 2.25 hours. After the addition of the second stage monomers was finished, the monomer mix tank was rinsed with component 26 and the batch was kept at 80° C. for 2 hours. Consequently, the dosing of the mixture of components 27 and 28 was finished 0.25 h before the end of this aging step. After the post-cook time had passed, the reactor contents was cooled to 23° C. When the temperature was reached, a mixture of components 29 and 30 was added to the reactor over a period of 0.5 hours, followed by component 31. The obtained multistage dispersion had a solids content of 24%, a (calculated) acid value of 19 mg KOH/g solid resin and a (calculated) hydroxyl value of 50 mg KOH/g solid resin.

### Examples 1 to 6 and Comparative Examples 1 and 2

### Preparation of Coating Formulations

Coating formulations were prepared to be tested as base coats. Preparation of the test formulations was done according a standard 2 pack metallic basecoat formulation. The ratio of acrylic binder (polyacrylate dispersion) and polyurethane dispersion (PUD binder) was kept constant, the amount of crosslinker was changed based on the resulting OH-content of the acrylic binder and the PUD used. An excess of crosslinker for each formulation was calculated, the crosslinking was done with a 40% excess of isocyanate calculated on the OH-content of the two binders. Table 3 below shows the formulation for the metallic basecoats tested, using the acrylic binder of Examples 1 to 6 and Comparative Examples 1 and 2.

TABLE 3

| Step | Nr | Components (ingredients) | Amount (parts) |
|---|---|---|---|
| A | 1 | Acrylic binder of Ex. 1 to 6, CEx.1 | 13.2 |
| | | and CEx.2 | |
| | | Polyurethane dispersion (DAOTAN ® | 9.1 |
| | | TW 7010/36WA, OHV of approximately | |
| | | 105 mg KOH/g) | |
| | | Dimethylethanolamine (DMEA)/10% | 1.2 |
| | | water | |
| | | Demi water | 4.0 |
| | 2 | Pigment wetting additive (ADDITOL ® | 0.1 |
| | | XL 250) | |
| | | Butylglycol | 19.9 |
| | | Metallic Pigment (STAPA ® IL | 6.0 |
| | | HYDROLAN ® S 2100) | |
| | 3 | Silicate thickener (LAPONITE ® RD) | 4.0 |
| | 4 | Acrylic thickener (RHEOVIS ® AS 1130) | 2.4 |
| | 5 | Surfactant (ADDITOL ® VXW 6214) | 0.4 |
| | | Wax additive (ULTRALUBE ® E500V) | 4.2 |
| | | Demi water | 13.5 |
| | | DMEA/20% Water | 1.3 |
| | 6 | Demi water | 20.7 |
| | | Sub-total | 100 |
| B | | Aliphatic polyisocyanate (HDI-Trimer) | 140% on OH |
| | | (DEMSODUR ® N3390) | |
| | | Butylacetate | variable |
| C | | Demi water (for spray application) | variable |

All components are mixed in the given order, as indicated in Table 3 hereabove, with a lab stirrer (Heidolph) at around 600-800 rpm. After formulation step A5, the coating formulation is stored overnight in order to give time to the thickeners for swelling. After addition of the isocyanate (pre-diluted in butylacetate) the formulations is adjusted with water deionized C to spray viscosity. Final viscosity is around 300-350 mPa*s at 23° C. and 25 shear rate. The hereby prepared coating formulation is immediately applied with a pneumatic spray gun (SATA RP 3000/4000/5000) around 1.5-2.0 bar air pressure.

After applying the coating formulation, flash off time is 10 minutes followed by 30 minutes at 80° C. cure in a lab drying oven with mechanical convection. The drying process is followed by a post-cure step where the dried panels are placed into an oven for 12 hours at 70° C. to guarantee full OH—NCO reaction of the binders and the isocyanate crosslinker.

### Test Results

Test results for base coats prepared as explained hereabove, for each of the polyacrylate dispersions of Examples 1 to 6 and Comparative Examples 1 and 2, are given in Table 4 below.

TABLE 4

| | Ex. | Ex. | Ex. | Ex. | Ex. | Ex. | CEx. | CEx. |
|---|---|---|---|---|---|---|---|---|
| | 1 | 2 | 3 | 4 | 5 | 6 | 1 | 2 |
| König | 95 | 120 | 137 | 117 | 125 | 128 | 102 | 149 |
| Hardness (s) | | | | | | | | |
| Flop Index | 14 | 13.5 | 20.9 | 15.7 | 14.4 | 15.7 | 15.3 | 19 |
| Gloss (60°) | 15 | 17.3 | 23.5 | 27 | 19.2 | 27.2 | 21 | 29 |

Resistance to

| | | | | | | | | |
|---|---|---|---|---|---|---|---|---|
| VW | fail | pass | pass | fail | fail | fail | fail | pass |
| hydrolysis | | | | | | | | |
| VW Hand | 10 | >15 | >15 | >15 | >15 | >15 | <10 | <10 |
| crème (N) | | | | | | | | |
| VW Sun | 15 | >15 | >15 | >15 | >15 | >15 | <10 | <10 |
| crème (N) | | | | | | | | |
| sunscreen/ | pass | pass | pass | pass | pass | pass | pass | pass |
| insect | | | | | | | | |
| repellent | | | | | | | | |
| GMW 14445 | | | | | | | | |

The above examples show that using the high OH-functional waterborne (aqueous) polyacrylate dispersion of the invention perform well for 2-coat and 1-coat metallic applications on plastics with excellent chemical resistance, more specifically with high resistance to sun cream and hand cream, in combination with good flop, gloss and hardness. Moreover, improved adhesion to plastic was obtained (compared to using polyacrylate dispersions described in the art).

1. An aqueous polyacrylate dispersion comprising a multiphase acrylic polymer, the multiphase acrylic polymer comprising at least two phases:
1) a vinyl polymer VP1 comprising:
a) 0-75 mole %, preferably 0-65 mole %, more preferably 0-60 mole %, even more preferably 0-55 mole % of (cyclo)alkyl (meth)acrylates of which the (cyclo)alkyl group contains 4-12 carbon atoms;
b) 10-60 mole %, preferably 15-50 mole %, more preferably 15-40 mole %, even more preferably 15-35 mole %, still even more preferably 20-30 mole %, most preferably 25-30 mole % of hydroxyalkyl (meth)acrylates; and
c) 0-25 mole %, preferably 0 mole %, of different, copolymerizable, monoethylenically unsaturated monomers;
d) 0-5 mole %, preferably 0-2 mole %, more preferably 0-1 mole %, of acid functional monoethylenically unsaturated monomers,
wherein the sum of mole percentages does not exceed 100%,
wherein the acid value of VP1 is lower or equal to 30 mg KOH/g, and
wherein the hydroxyl number of vinyl polymer VP1 is of 100-250 mg KOH/g,
and
2) a vinyl polymer VP2 comprising:
a) 0-50 mole %, preferably 10-40 mole %, more preferably 20-30 mole % of acid functional monoethylenically unsaturated monomers, and
b) 50-100 mole %, preferably 60-90 mole %, more preferably 70-80 mole % of hydroxyalkyl (meth)acrylates or different, copolymerizable, monoethylenically unsaturated monomers, or a mixture thereof,
wherein the sum of mole percentages does not exceed 100%, and
wherein the multiphase acrylic polymer is prepared by multiple step emulsion polymerization comprising at least the following subsequent steps i) and ii):
i. preparing 70-95, preferably 75-90, parts by weight (calculated on 100 parts by weight of the prepared copolymer) of vinyl polymer VP1, and subsequently
ii. preparing 5-30, preferably 10-25, parts by weight (calculated on 100 parts by weight of the prepared copolymer) of vinyl polymer VP2, in the presence of vinyl polymer VP1;
or
i. preparing 5-30, preferably 10-25, parts by weight (calculated on 100 parts by weight of the prepared copolymer) of vinyl polymer VP2, and subsequently
ii. preparing 70-95, preferably 75-90, parts by weight (calculated on 100 parts by weight of the prepared copolymer) of vinyl polymer VP1, in the presence of vinyl polymer VP2.

2. The aqueous polyacrylate dispersion of claim 1, wherein the (cyclo)alkyl (meth)acrylate of which the (cyclo)alkyl group contains 4-12 carbon atoms in VP1 is n-butyl acrylate (n-BA), butyl methacrylate (BMA), 2-ethylhexyl (meth)acrylate (2-EH(M)A), or a mixture thereof.

3. The aqueous polyacrylate dispersion of claim 1, wherein the hydroxyalkyl (meth)acrylate in VP1 and/or VP2 is 2-hydroxyethyl methacrylate (2-HEMA), 2-hydroxyethyl acrylate (2-HEA), or 4-hydroxybutyl acrylate (4-HBA), or a mixture thereof.

4. The aqueous polyacrylate dispersion of claim 1, wherein the different, copolymerizable, monoethylenically unsaturated monomer in VP1 is methyl (meth)acrylate, (meth)acrylamide, styrene, or a mixture thereof.

5. The aqueous polyacrylate dispersion of claim 1, wherein the different, copolymerizable, monoethylenically unsaturated monomer in VP2 is n-butyl (meth)acrylate, or methyl (meth)acrylate, styrene, or a mixture thereof.

6. The aqueous polyacrylate dispersion of claim 1, wherein the acid functional monoethylenically unsaturated monomer in VP1, if present, is (meth)acrylic acid and/or the acid functional monoethylenically unsaturated monomer in VP2 is (meth)acrylic acid.

7. The aqueous polyacrylate dispersion of claim 1, wherein the multiphase acrylic polymer has an OH value of at least 55 mg KOH/g.

8. The aqueous polyacrylate dispersion of claim 1, wherein the vinyl polymer VP1 comprises at least one emulsifier of anionic and/or non-ionic nature, preferably the emulsifier comprises an olefinically unsaturated group, the sum of mole percentages of a), b), c), d) and reactive emulsifier not exceeding 100%.

9. The aqueous polyacrylate dispersion of claim 8, wherein the amount of emulsifier solids used in the synthesis of vinyl polymer VP1 is 0.1 to 15 weight % (based on the weight of vinyl polymer VP1).

10. The aqueous polyacrylate dispersion of claim 1, wherein the acid value of vinyl polymer VP2 is strictly higher than 30 mg KOH/g.

11. The aqueous polyacrylate dispersion of claim 1, wherein vinyl polymer VP1 comprises 0-75 mole % of butyl methacrylate, 20-30 mole % of 2-hydroxyethyl methacrylate, 0 mole % of different, copolymerizable, monoethylenically unsaturated monomers, and 0-2 mole % of acid functional monoethylenically unsaturated monomers; and wherein vinyl polymer VP2 comprises 20-30 mole % of methacrylic acid and 70-80 mole % of a mixture of 2-hydroxyethyl acrylate, n-butyl acrylate and methyl methacrylate; the multiphase acrylic polymer being prepared by multiple step emulsion polymerization comprising at least a step of preparing 75-90 parts by weight of vinyl polymer VP1, and subsequently a step of preparing 10-25 parts by weight of vinyl polymer VP2 in the presence of vinyl polymer VP1.

12. The aqueous polyacrylate dispersion of claim 1, wherein the monoethylenically unsaturated monomers for vinyl polymer VP1 and/or VP2 are obtained from renewable feedstock and have a bio-based carbon content of more than 20% by weight of total carbon content of the monomer, the bio-carbon content being determined using the ASTM D6866-20 standard, and/or wherein the monoethylenically unsaturated monomers for vinyl polymer VP1 and/or VP2 are recycled monomers.

13. The aqueous polyacrylate dispersion of claim 1, wherein the aqueous polyacrylate dispersion is applied on a substrate for the refinishing of cars, the finishing of trucks, buses, trains, and airplanes, and the finishing of cars, more preferably for metallic coatings on metals and plastics for automotive OEM.

14. An aqueous coating composition comprising:
0.1 to 100 wt % of the aqueous polyacrylate dispersion PAD according to claim 1,
optionally, from 0.1 to 50 wt % of a polyurethane dispersion PUD, and/or
optionally, from 0.1 to 15 wt % of a crosslinker C,
based on the sum of PAD, and, if present, PUD and crosslinker C.

15. The aqueous coating composition of claim 14 comprising from 0.1 to 50 wt % of the polyurethane dispersion PUD, the polyurethane dispersion having a OH value of at least 35 mg KOH/g, preferably the polyurethane dispersion comprises at least:
a polyurethane U1 having a weight-average molar mass Mw1 of at least 10 kg/mole, and
a polyurethane U2 having a weight-average molar mass Mw2 of less than 10 kg/mole, the weight-average molar mass being determined by size exclusion chromatography in tetrahydrofuran, relative to polystyrene standards, and the polyurethane U2 further having:
a specific amount of substance, in accordance with DIN 32 625, of hydroxyl groups n(—OH)/m(U2) of from 1.4 mole/kg to 4 mole/kg,
a degree of branching, in accordance with DIN 32 625, of up to 0.5 mole/kg, and
a specific amount of substance, in accordance with DIN 32 625, of urea groups n(—NH—CO—NH—)/m(U2) of from 0.8 mole/kg to 2 mole/kg.

16. The aqueous coating composition of claim 14, wherein a crosslinker C is present, the crosslinker being selected from the group consisting of polyisocyanates, blocked polyisocyanates, amino resins such as melamine-formaldehyde resins and formaldehyde free based resins, and mixtures of amino resins with polyisocyanates, preferably crosslinker C is a polyisocyanate crosslinker.

17. The aqueous coating composition of any claim 14, comprising at least one or more conventional ingredients selected from the group consisting of non-vinyl polymers, pigments, dyes, emulsifiers, surfactants, plasticizers, thickeners, heat stabilizers, levelling agents, anti-cratering agents, fillers, sedimentation inhibitors, UV absorbers, antioxidants, organic co-solvents, wetting agents and the like, and mixtures thereof.

18. A method of making a coating composition according to claim 17, comprising the steps of blending a aqueous polyacrylate dispersion PAD with at least one or more conventional ingredients selected from the group consisting of non-vinyl polymers, pigments, dyes, emulsifiers, surfactants, plasticizers, thickeners, heat stabilizers, levelling agents, anti-cratering agents, fillers, sedimentation inhibitors, UV absorbers, antioxidants, organic co-solvents, wetting agents and the like, and mixtures thereof,
wherein the aqueous polyacrylate dispersion PAD comprises a multiphase acrylic polymer, the multiphase acrylic polymer comprising at least two phases:
1) a vinyl polymer VP1 comprising:
a) 0-75 mole %, preferably 0-65 mole %, more preferably 0-60 mole %, even more preferably 0-55 mole % of (cyclo)alkyl (meth)acrylates of which the (cyclo)alkyl group contains 4-12 carbon atoms;
b) 10-60 mole %, preferably 15-50 mole %, more preferably 15-40 mole %, even more preferably 15-35 mole %, still even more preferably 20-30 mole %, most preferably 25-30 mole % of hydroxyalkyl (meth)acrylates; and
c) 0-25 mole %, preferably 0 mole %, of different, copolymerizable, monoethylenically unsaturated monomers;
d) 0-5 mole %, preferably 0-2 mole %, more preferably 0-1 mole %, of acid functional monoethylenically unsaturated monomers,
wherein the sum of mole percentages does not exceed 100%,
wherein the acid value of VP1 is lower or equal to 30 mg KOH/g, and
wherein the hydroxyl number of vinyl polymer VP1 is of 100-250 mg KOH/g,
and
2) a vinyl polymer VP2 comprising:
a) 0-50 mole %, preferably 10-40 mole %, more preferably 20-30 mole % of acid functional monoethylenically unsaturated monomers, and
b) 50-100 mole %, preferably 60-90 mole %, more preferably 70-80 mole % of hydroxyalkyl (meth)acrylates or different, copolymerizable, monoethylenically unsaturated monomers, or a mixture thereof,
wherein the sum of mole percentages does not exceed 100%, and
wherein the multiphase acrylic polymer is prepared by multiple step emulsion polymerization comprising at least the following subsequent steps i) and ii):
i. preparing 70-95, preferably 75-90, parts by weight (calculated on 100 parts by weight of the prepared copolymer) of vinyl polymer VP1, and subsequently
ii. preparing 5-30, preferably 10-25, parts by weight (calculated on 100 parts by weight of the prepared copolymer) of vinyl polymer VP2, in the presence of vinyl polymer VP1;
or
i. preparing 5-30, preferably 10-25, parts by weight (calculated on 100 parts by weight of the prepared copolymer) of vinyl polymer VP2, and subsequently
ii. preparing 70-95, preferably 75-90, parts by weight (calculated on 100 parts by weight of the prepared copolymer) of vinyl polymer VP1, in the presence of vinyl polymer VP2.

19. The aqueous coating composition of claim 14, wherein aqueous coating composition is applied on a substrate for the refinishing of cars, the finishing of trucks, buses, trains, and aero planes, and the finishing of cars, preferably for metallic coatings on metals and plastics for automotive OEM.

20. Metal or plastic substrate, preferably a plastic substrate, coated with a composition according to claim 14.
